(19) United States
(12) Patent Application Publication
(10) Pub. No.: US 2023/0020389 A1
(43) Pub. Date: Jan. 19, 2023

(54) Executing a Quantum Logic Circuit on Multiple Processing Nodes

(71) Applicant: Rigetti & Co, LLC, Berkeley, CA (US)

(72) Inventors: Erik Joseph Davis, Berkeley, CA (US); Mark Skilbeck, Nottingham (GB); Thomas Lubowe, Laguna Hills, CA (US)

(73) Assignee: Rigetti & Co, LLC, Berkeley, CA (US)

(21) Appl. No.: 17/861,818

(22) Filed: Jul. 11, 2022

Related U.S. Application Data
(60) Provisional application No. 63/220,216, filed on Jul. 9, 2021.

(51) Int. Cl. G06F 30/3308; G06N 10/20; G06F 9/50

(52) U.S. Cl. CPC G06F 30/3308; G06N 10/20; G06F 9/5033

(57) ABSTRACT

In a general aspect, a quantum logic circuit is executed on multiple processing nodes in a computing system that includes quantum computing resources. In some aspects, methods of operating the computing system may include obtaining a computer program that includes a quantum logic circuit. The methods may include obtaining hardware resource metadata specifying properties of processing nodes in the computing system. The processing nodes include at least a subset of the quantum computing resources, and the hardware resource metadata includes error rate information and availability information for the respective processing nodes. The methods may include generating execution tasks configured to execute the quantum logic circuit on the processing nodes based on the hardware resource metadata; dispatching the execution tasks to the processing nodes; receiving output data generated by the processing nodes; and producing an output of the computer program based on the output data.

### CROSS-REFERENCE TO RELATED APPLICATIONS

This application claims priority to U.S. Provisional Patent Application No. 63/220,216, filed Jul. 9, 2021, entitled “Concurrent Scheduling and Execution of a Quantum Logic Circuit on Heterogenous Computing Resources.” The above-referenced priority document is incorporated herein by reference in its entirety.

### BACKGROUND

The following description relates to executing a quantum logic circuit on multiple processing nodes, for example, in a quantum or hybrid computing system.

Quantum computers can perform computational tasks by storing and processing information within quantum states of quantum systems. For example, qubits (i.e., quantum bits) can be stored in and represented by an effective two-level sub-manifold of a quantum coherent physical system. A variety of physical systems have been proposed for quantum computing applications. Examples include superconducting quantum circuits, trapped ions, spin systems, and others.

### BRIEF DESCRIPTION OF THE DRAWINGS

FIG. 1 is a block diagram of an example computing system.

FIG. 2 is a schematic diagram showing aspects of an example process for decomposing a quantum logic circuit.

FIG. 3 is a schematic diagram showing aspects of an example process for cutting external connections between quantum logic blocks from a decomposition of an example quantum logic circuit.

FIG. 4A is a schematic diagram showing aspects of an example execution task.

FIG. 4B is a schematic diagram showing aspects of an example execution schedule.

FIG. 5 is a flow chart showing aspects of an example process.

FIGS. 6A-6C are schematic diagrams showing aspects of example execution schedules.

### DETAILED DESCRIPTION

In some aspects of what is described here, heterogeneous hardware in a hybrid computing system including mixed classical and quantum computing resources is used for parallel or concurrent execution of quantum logic circuits, which may be, for example, embedded within a larger mixed classical-quantum workflow or pipeline. A quantum logic circuit can be decomposed into quantum logic blocks according to a cost-based circuit decomposition process as part of a “scatter, gather, update” algorithm and an available set of heterogenous hardware. In some implementations, hardware constraints imposed by Noisy Intermediate-Scale Quantum (NISQ) technology, e.g., block length of quantum logic blocks, are also considered in the decomposition process. A cost-based decomposition process allows balancing of hardware compatibility, average number of executable quantum logic blocks per resource, and hardware error rates. The quantum logic circuit after decomposition can be translated into an execution schedule including execution tasks which are associated with the quantum logic blocks.

The execution schedule can be executed by the hybrid computing system which has a cluster architecture which includes a cluster server and processing nodes. A cluster server in the hybrid computing system is configured to receive requests from users, to coordinate a broad logical control flow of the “scatter, gather, update” algorithm, and to return task results (e.g., an estimated value of an identity) to the users. The methods and techniques presented here allow a mechanism to “update and continue” in response to hardware failure or hardware updates during long-running jobs.

In some implementations, the systems and techniques described here can provide technical advantages and improvements. For example, the methods and techniques presented here can increase hardware utilization, increase the quantum computational power, increase the duty cycle of the quantum computing resources, and thus reduce per unit cost of quantum computing resources during the execution of quantum logic circuits. The systems and methods presented here allows for the evaluation of a quantum logic circuit using any particular hardware resource and allow the evaluation of a single quantum logic circuit using computing resources in tandem. The methods and techniques presented here enable the ability to share computing resources across users. The methods and techniques disclosed here allow error recovery and allow for updating the hardware configuration during executions of long-running jobs. In some cases, a combination of these and potentially other advantages and improvements may be obtained.

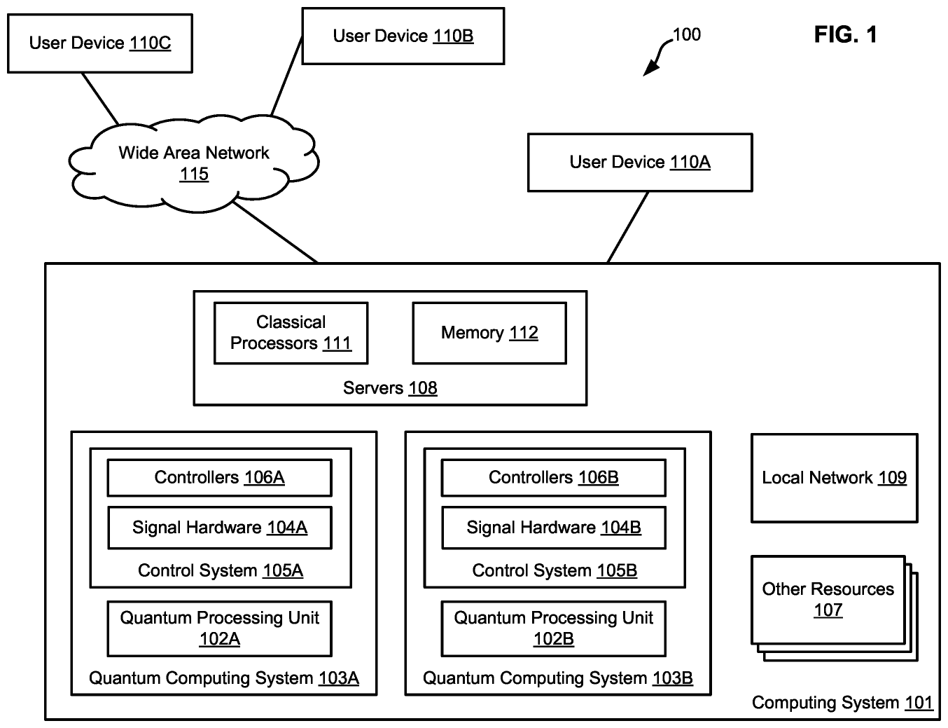

FIG. 1 is a block diagram of an example computing environment 100. The example computing environment 100 shown in FIG. 1 includes a computing system 101 and user devices 110A, 110B, 110C. A computing environment may include additional or different features, and the components of a computing environment may operate as described with respect to FIG. 1 or in another manner.

The example computing system 101 includes classical and quantum computing resources and exposes their functionality to the user devices 110A, 110B, 110C (referred to collectively as “user devices 110”). The computing system 101 shown in FIG. 1 includes one or more servers 108, quantum computing systems 103A, 103B, a local network 109, and other resources 107. The computing system 101 may also include one or more user devices (e.g., the user device 110A) as well as other features and components. A computing system may include additional or different features, and the components of a computing system may operate as described with respect to FIG. 1 or in another manner.

The example computing system 101 can provide services to the user devices 110, for example, as a cloud-based or remote-accessed computer system, as a distributed computing resource, as a supercomputer or another type of high-performance computing resource, or in another manner. The computing system 101 or the user devices 110 may also have access to one or more other quantum computing systems (e.g., quantum computing resources that are accessible through the wide area network 115, the local network 109, or otherwise).

The user devices 110 shown in FIG. 1 may include one or more classical processors, memory, user interfaces, communication interfaces, and other components. For instance, the user devices 110 may be implemented as laptop computers, desktop computers, smartphones, tablets, or other types of computer devices. In the example shown in FIG. 1, to access computing resources of the computing system 101, the user devices 110 send information (e.g., programs, instructions, commands, requests, input data, etc.) to the servers 108; and in response, the user devices 110 receive information (e.g., application data, output data, prompts, alerts, notifications, results, etc.) from the servers 108. The user devices 110 may access services of the computing system 101 in another manner, and the computing system 101 may expose computing resources in another manner.

In the example shown in FIG. 1, the local user device 110A operates in a local environment with the servers 108 and other elements of the computing system 101. For instance, the user device 110A may be co-located with (e.g., located within 0.5 to 1 km of) the servers 108 and possibly other elements of the computing system 101. As shown in FIG. 1, the user device 110A communicates with the servers 108 through a local data connection.

The local data connection in FIG. 1 is provided by the local network 109. For example, some or all of the servers 108, the user device 110A, the quantum computing systems 103A, 103B and the other resources 107 may communicate with each other through the local network 109. In some implementations, the local network 109 operates as a communication channel that provides one or more low-latency communication pathways from the server 108 to the quantum computer systems 103A, 103B (or to one or more of the elements of the quantum computer systems 103A, 103B). The local network 109 can be implemented, for instance, as a wired or wireless Local Area Network, an Ethernet connection, or another type of wired or wireless connection. The local network 109 may include one or more wired or wireless routers, wireless access points (WAPs), wireless mesh nodes, switches, high-speed cables, or a combination of these and other types of local network hardware elements. In some cases, the local network 109 includes a software-defined network that provides communication among virtual resources, for example, among an array of virtual machines operating on the server 108 and possibly elsewhere.

In the example shown in FIG. 1, the remote user devices 110B, 110C operate remote from the servers 108 and other elements of the computing system 101. For instance, the user devices 110B, 110C may be located at a remote distance (e.g., more than 1 km, 10 km, 100 km, 1,000 km, 10,000 km, or farther) from the servers 108 and possibly other elements of the computing system 101. As shown in FIG. 1, each of the user devices 110B, 110C communicates with the servers 108 through a remote data connection.

The remote data connection in FIG. 1 is provided by a wide area network 115, which may include, for example, the Internet or another type of wide area communication network. In some cases, remote user devices use another type of remote data connection (e.g., satellite-based connections, a cellular network, a virtual private network, etc.) to access the servers 108. The wide area network 115 may include one or more internet servers, firewalls, service hubs, base stations, or a combination of these and other types of remote networking elements. Generally, the computing environment 100 can be accessible to any number of remote user devices.

The example servers 108 shown in FIG. 1 can manage interaction with the user devices 110 and utilization of the quantum and classical computing resources in the computing system 101. For example, based on information from the user devices 110, the servers 108 may delegate computational tasks to the quantum computing systems 103A, 103B and the other resources 107; the servers 108 can then send information to the user devices 110 based on output data from the computational tasks performed by the quantum computing systems 103A, 103B, and the other resources 107.

As shown in FIG. 1, the servers 108 are classical computing resources that include classical processors 111 and memory 112. The servers 108 may also include one or more communication interfaces that allow the servers to communicate via the local network 109, the wide area network 115, and possibly other channels. In some implementations, the servers 108 may include a host server, an application server, a virtual server, or a combination of these and other types of servers. The servers 108 may include additional or different features, and may operate as described with respect to FIG. 1 or in another manner.

The classical processors 111 can include various kinds of apparatus, devices, and machines for processing data, including, by way of example, a microprocessor, a central processing unit (CPU), a graphics processing unit (GPU), an FPGA (field programmable gate array), an ASIC (application specific integrated circuit), or combinations of these. The memory 112 can include, for example, a random-access memory (RAM), a storage device (e.g., a writable read-only memory (ROM) or others), a hard disk, or another type of storage medium. The memory 112 can include various forms of volatile or non-volatile memory, media, and memory devices, etc.

Each of the example quantum computing systems 103A, 103B operates as a quantum computing resource in the computing system 101. The other resources 107 may include additional quantum computing resources (e.g., quantum computing systems, quantum simulators, or both) as well as classical (non-quantum) computing resources such as, for example, digital microprocessors, specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), etc., or combinations of these and other types of computing modules.

In some implementations, the servers 108 generate programs, identify appropriate computing resources (e.g., quantum processing unit (QPU) or quantum virtual machine (QVM)) in the computing system 101 to execute the programs, and send the programs to the identified resources for execution. For example, the servers 108 may send programs to the quantum computing system 103A, the quantum computing system 103B, or any of the other resources 107. The programs may include classical programs, quantum programs, hybrid classical/quantum programs, and may include any type of function, code, data, instruction set, etc.

In some instances, programs can be formatted as source code that can be rendered in human-readable form (e.g., as text) and can be compiled, for example, by a compiler running on the servers 108, on the quantum computing systems 103, or elsewhere. In some instances, programs can be formatted as compiled code, such as, for example, binary code (e.g., machine-level instructions) that can be executed directly by a computing resource. Each program may include instructions corresponding to computational tasks that, when performed by an appropriate computing resource, generate output data based on input data. For example, a program can include instructions formatted for a quantum computer system, a simulator, a digital microprocessor, co-processor or other classical data processing apparatus, or another type of computing resource.

In some cases, a program may be expressed in a hardware-independent format. For example, quantum machine instructions may be provided in a quantum instruction language such as Quil, described in the publication “A Practical Quantum Instruction Set Architecture,” arXiv:1608.03355v2, dated Feb. 17, 2017, or another quantum instruction language. For instance, the quantum machine instructions may be written in a format that can be executed by a broad range of quantum processing units or simulators. In some cases, a program may be expressed in high-level terms of quantum logic gates or quantum algorithms, in lower-level terms of fundamental qubit rotations and controlled rotations, or in another form. In some cases, a program may be expressed in terms of control signals (e.g., pulse sequences, delays, etc.) and parameters for the control signals (e.g., frequencies, phases, durations, channels, etc.). In some cases, a program may utilize Quil-T, described in the publication “Gain deeper control of Rigetti quantum processors with Quil-T,” available at https://medium.com/rigetti/gain-deeper-control-of-rigetti-quantum-processors-with-quil-t-ea8943061e5b, dated Dec. 10, 2020. In some cases, a program may be expressed in another form or format.

In some implementations, the servers 108 include one or more compilers that convert programs between formats. For example, the servers 108 may include a compiler that converts hardware-independent instructions to binary programs for execution by the quantum computing systems 103A, 103B. In some cases, a compiler can compile a program to a format that targets a specific quantum resource in the computer system 101. For example, a compiler may generate a different binary program (e.g., from the same source code) depending on whether the program is to be executed by the quantum computing system 103A or the quantum computing system 103B.

In some cases, a compiler generates a partial binary program that can be updated, for example, based on specific parameters. For instance, if a quantum program is to be executed iteratively on a quantum computing system with varying parameters on each iteration, the compiler may generate the binary program in a format that can be updated with specific parameter values at runtime (e.g., based on feedback from a prior iteration, or otherwise); the parametric update can be performed without further compilation. In some cases, a compiler generates a full binary program that does not need to be updated or otherwise modified for execution.

In some implementations, the servers 108 generate a schedule for executing programs, allocate computing resources in the computing system 101 according to the schedule, and delegate the programs to the allocated computing resources. The servers 108 can receive, from each computing resource, output data from the execution of each program. Based on the output data, the servers 108 may generate additional programs that are then added to the schedule, output data that is provided back to a user device 110, or perform another type of action.

In some implementations, all or part of the computing environment operates as a cloud-based quantum computing (QC) environment, and the servers 108 operate as a host system for the cloud-based QC environment. The cloud-based QC environment may include software elements that operate on both the user devices 110 and the computer system 101 and interact with each other over the wide area network 115. For example, the cloud-based QC environment may provide a remote user interface, for example, through a browser or another type of application on the user devices 110. The remote user interface may include, for example, a graphical user interface or another type of user interface that obtains input provided by a user of the cloud-based QC environment. In some cases the remote user interface includes, or has access to, one or more application programming interfaces (APIs), command line interfaces, graphical user interfaces, or other elements that expose the services of the computer system 101 to the user devices 110.

In some cases, the cloud-based QC environment may be deployed in a “serverless” computing architecture. For instance, the cloud-based QC environment may provide on-demand access to a shared pool of configurable computing resources (e.g., networks, servers, storage, applications, services, quantum computing resources, classical computing resources, etc.) that can be provisioned for requests from user devices 110. Moreover, the cloud-based computing systems 101 may include or utilize other types of computing resources, such as, for example, edge computing, fog computing, etc.

In an example implementation of a cloud-based QC environment, the servers 108 may operate as a cloud provider that dynamically manages the allocation and provisioning of physical computing resources (e.g., GPUs, CPUs, QPUs, etc.). Accordingly, the servers 108 may provide services by defining virtualized resources for each user account. For instance, the virtualized resources may be formatted as virtual machine images, virtual machines, containers, or virtualized resources that can be provisioned for a user account and configured by a user. In some cases, the servers 108 include a container management and execution system that is implemented, for example, using KUBERNETES® or another software platform for container management. In some cases, the cloud-based QC environment is implemented, for example, using OPENSTACK® or another software platform for cloud-based computing that provides virtual servers or other virtual computing resources for users.

In some cases, the server 108 stores quantum machine images (QMI) for each user account. A quantum machine image may operate as a virtual computing resource for users of the cloud-based QC environment. For example, a QMI can provide a virtualized development and execution environment to develop and run programs (e.g., quantum programs or hybrid classical/quantum programs). When a QMI operates on the server 108, the QMI may engage either of the quantum processor units 102A, 102B, and interact with a remote user device (110B or 110C) to provide a user programming environment. The QMI may operate in close physical proximity to, and have a low-latency communication link with, the quantum computing systems 103A, 103B. In some implementations, remote user devices connect with QMIs operating on the servers 108 through secure shell (SSH) or other protocols over the wide area network 115.

In some implementations, all or part of the computing system 101 operates as a hybrid computing environment. For example, quantum programs can be formatted as hybrid classical/quantum programs that include instructions for execution by one or more quantum computing resources and instructions for execution by one or more classical resources. The servers 108 can allocate quantum and classical computing resources in the hybrid computing environment, and delegate programs to the allocated computing resources for execution. The quantum computing resources in the hybrid environment may include, for example, one or more QPUs, one or more quantum simulators (e.g., QVMs), or possibly other types of quantum resources. The classical computing resources in the hybrid environment may include, for example, one or more digital microprocessors, one or more specialized co-processor units (e.g., graphics processing units (GPUs), cryptographic co-processors, etc.), special purpose logic circuitry (e.g., field programmable gate arrays (FPGAs), application-specific integrated circuits (ASICs), etc.), systems-on-chips (SoCs), or other types of computing modules.

In some cases, the servers 108 can select the type of computing resource (e.g., quantum or classical) to execute an individual program, or part of a program, in the computing system 101. For example, the servers 108 may select a QPU, QVM, or other computing resource based on availability of the resource, speed of the resource, information or state capacity of the resource, a performance metric (e.g., process fidelity) of the resource, supported quantum gates, metadata indicating (in part) timing and fidelity information about these gates, or based on a combination of these and other factors. In embodiments involving QVMs, the servers 108 may select a QVM based on metadata indicating, in part, limitations on the circuit size or complexity, and timing information capturing the run-time cost of simulating circuits of various sizes. In some cases, the servers 108 can perform load balancing, resource testing and calibration, and other types of operations to improve or optimize computing performance.

Each of the example quantum computing systems 103A, 103B shown in FIG. 1 can perform quantum computational tasks by executing quantum machine instructions (e.g., a binary program compiled for the quantum computing system). In some implementations, a quantum computing system can perform quantum computation by storing and manipulating information within quantum states of a composite quantum system. For example, qubits (i.e., quantum bits) can be stored in, and represented by, an effective two-level sub-manifold of a quantum coherent physical system. Qudits (i.e., quantum digits) represented by a multi-level quantum system providing a larger state space can be also defined by a qubit device. In some instances, quantum logic can be executed in a manner that allows large-scale entanglement within the quantum system. Control signals can manipulate the quantum states of individual qubits and the joint states of multiple qubits. In some instances, information can be read out from the composite quantum system by measuring the quantum states of the qubits. In some implementations, the quantum states of the qubits are read out by measuring the transmitted or reflected signal from auxiliary quantum devices that are coupled to individual qubits.

In some implementations, a quantum computing system can operate using gate-based models for quantum computing. For example, the qubits can be initialized in an initial state, and a quantum logic circuit comprised of a series of quantum logic gates can be applied to transform the qubits and extract measurements representing the output of the quantum computation. Individual qubits may be controlled by single-qubit quantum logic gates, and pairs of qubits may be controlled by two-qubit quantum logic gates (e.g., entangling gates that are capable of generating entanglement between the pair of qubits). In some implementations, a quantum computing system can operate using adiabatic or annealing models for quantum computing. For instance, the qubits can be initialized in an initial state, and the controlling Hamiltonian can be transformed adiabatically by adjusting control parameters to another state that can be measured to obtain an output of the quantum computation.

In some models, fault-tolerance can be achieved by applying a set of high-fidelity control and measurement operations to the qubits. For example, quantum error correcting schemes can be deployed to achieve fault-tolerant quantum computation. Other computational regimes may be used; for example, quantum computing systems may operate in non-fault-tolerant regimes. In some implementations, a quantum computing system is constructed and operated according to a scalable quantum computing architecture. For example, in some cases, the architecture can be scaled to a large number of qubits to achieve large-scale general purpose coherent quantum computing. Other architectures may be used; for example, quantum computing systems may operate in small-scale or non-scalable architectures.

The example quantum computing system 103A shown in FIG. 1 includes a quantum processing unit 102A and a control system 105A, which controls the operation of the quantum processing unit 102A. Similarly, the example quantum computing system 103B includes a quantum processing unit 102B and a control system 105B, which controls the operation of a quantum processing unit 102B. A quantum computing system may include additional or different features, and the components of a quantum computing system may operate as described with respect to FIG. 1 or in another manner.

In some instances, all or part of the quantum processing unit 102A functions as a quantum processor, a quantum memory, or another type of subsystem. In some examples, the quantum processing unit 102A includes a quantum circuit system. The quantum circuit system may include qubit devices, readout devices, and possibly other devices that are used to store and process quantum information. In some cases, the quantum processing unit 102A includes a QPU sublattice, and the qubit devices are implemented as circuit devices that include Josephson junctions, for example, in superconducting quantum interference device (SQUID) loops or other arrangements, and are controlled by radio-frequency signals, microwave signals, and bias signals delivered to the quantum processing unit 102A. In some cases, the quantum processing unit 102A includes an ion trap system, and the qubit devices are implemented as trapped ions controlled by optical signals delivered to the quantum processing unit 102A. In some cases, the quantum processing unit 102A includes a spin system, and the qubit devices are implemented as nuclear or electron spins controlled by microwave or radio-frequency signals delivered to the quantum processing unit 102A. The quantum processing unit 102A may be implemented based on another physical modality of quantum computing.

The quantum processing unit 102A may include, or may be deployed within, a controlled environment. The controlled environment can be provided, for example, by shielding equipment, cryogenic equipment, and other types of environmental control systems. In some examples, the components in the quantum processing unit 102A operate in a cryogenic temperature regime and are subject to very low electromagnetic and thermal noise. For example, magnetic shielding can be used to shield the system components from stray magnetic fields, optical shielding can be used to shield the system components from optical noise, and thermal shielding and cryogenic equipment can be used to maintain the system components at a controlled temperature, etc.

In some implementations, the example quantum processing unit 102A can process quantum information by applying control signals to the qubits in the quantum processing unit 102A. The control signals can be configured to encode information in the qubits, to process the information by performing quantum logic gates or other types of operations, or to extract information from the qubits. In some examples, the operations can be expressed as single-qubit quantum logic gates, two-qubit quantum logic gates, or other types of quantum logic gates that operate on one or more qubits. A quantum logic circuit, which includes a sequence of quantum logic operations, can be applied to the qubits to perform a quantum algorithm. The quantum algorithm may correspond to a computational task, a hardware test, a quantum error correction procedure, a quantum state distillation procedure, or a combination of these and other types of operations.

The example control system 105A includes controllers 106A and signal hardware 104A. Similarly, control system 105B includes controllers 106B and signal hardware 104B. All or part of the control systems 105A, 105B can operate in a room-temperature environment or another type of environment, which may be located near the respective quantum processing units 102A, 102B. In some cases, the control systems 105A, 105B include classical computers, signaling equipment (microwave, radio, optical, bias, etc.), electronic systems, vacuum control systems, refrigerant control systems, or other types of control systems that support operation of the quantum processing units 102A, 102B.

The control systems 105A, 105B may be implemented as distinct systems that operate independent of each other. In some cases, the control systems 105A, 105B may include one or more shared elements; for example, the control systems 105A, 105B may operate as a single control system that operates both quantum processing units 102A, 102B. Moreover, a single quantum computer system may include multiple quantum processing units, which may operate in the same controlled (e.g., cryogenic) environment or in separate environments.

The example signal hardware 104A includes components that communicate with the quantum processing unit 102A. The signal hardware 104A may include, for example, waveform generators, amplifiers, digitizers, high-frequency sources, DC sources, AC sources, etc. The signal hardware may include additional or different features and components. In the example shown, components of the signal hardware 104A are adapted to interact with the quantum processing unit 102A. For example, the signal hardware 104A can be configured to operate in a particular frequency range, configured to generate and process signals in a particular format, or the hardware may be adapted in another manner.

In some instances, one or more components of the signal hardware 104A generate control signals, for example, based on control information from the controllers 106A. The control signals can be delivered to the quantum processing unit 102A during operation of the quantum computing system 103A. For instance, the signal hardware 104A may generate signals to implement quantum logic operations, readout operations, or other types of operations. As an example, the signal hardware 104A may include arbitrary waveform generators (AWGs) that generate electromagnetic waveforms (e.g., microwave or radio-frequency) or laser systems that generate optical waveforms. The waveforms or other types of signals generated by the signal hardware 104A can be delivered to devices in the quantum processing unit 102A to operate qubit devices, readout devices, bias devices, coupler devices, or other types of components in the quantum processing unit 102A.

In some instances, the signal hardware 104A receives and processes signals from the quantum processing unit 102A. The received signals can be generated by the execution of a quantum program on the quantum computing system 103A. For instance, the signal hardware 104A may receive signals from the devices in the quantum processing unit 102A in response to readout or other operations performed by the quantum processing unit 102A. Signals received from the quantum processing unit 102A can be mixed, digitized, filtered, or otherwise processed by the signal hardware 104A to extract information, and the information extracted can be provided to the controllers 106A or handled in another manner. In some examples, the signal hardware 104A may include a digitizer that digitizes electromagnetic waveforms (e.g., microwave or radio-frequency) or optical signals, and a digitized waveform can be delivered to the controllers 106A or to other signal hardware components. In some instances, the controllers 106A process the information from the signal hardware 104A and provide feedback to the signal hardware 104A; based on the feedback, the signal hardware 104A can in turn generate new control signals that are delivered to the quantum processing unit 102A.

In some implementations, the signal hardware 104A includes signal delivery hardware that interfaces with the quantum processing unit 102A. For example, the signal hardware 104A may include filters, attenuators, directional couplers, multiplexers, diplexers, bias components, signal channels, isolators, amplifiers, power dividers, and other types of components. In some instances, the signal delivery hardware performs preprocessing, signal conditioning, or other operations to the control signals to be delivered to the quantum processing unit 102A. In some instances, signal delivery hardware performs preprocessing, signal conditioning or other operations on readout signals received from the quantum processing unit 102A.

The example controllers 106A communicate with the signal hardware 104A to control operation of the quantum computing system 103A. The controllers 106A may include classical computing hardware that directly interfaces with components of the signal hardware 104A. The example controllers 106A may include classical processors, memory, clocks, digital circuitry, analog circuitry, and other types of systems or subsystems. The classical processors may include one or more single- or multi-core microprocessors, digital electronic controllers, special purpose logic circuitry, e.g., an FPGA (field programmable gate array) or an ASIC (application specific integrated circuit), or other types of data processing apparatus. The memory may include any type of volatile or non-volatile memory or another type of computer storage medium. The controllers 106A may also include one or more communication interfaces that allow the controllers 106A to communicate via the local network 109 and possibly other channels. The controllers 106A may include additional or different features and components.

In some implementations, the controllers 106A include memory or other components that store quantum state information, for example, based on qubit readout operations performed by the quantum computing system 103A. For instance, the states of one or more qubits in the quantum processing unit 102A can be measured by qubit readout operations, and the measured state information can be stored in a cache or other type of memory system in one or more of the controllers 106A. In some cases, the measured state information is subsequently used in the execution of a quantum program, a quantum error correction procedure, a QPU calibration or testing procedure, or another type of quantum process.

In some implementations, the controllers 106A include memory or other components that store a quantum program containing quantum machine instructions for execution by the quantum computing system 103A. In some instances, the controllers 106A can interpret the quantum machine instructions and perform hardware-specific control operations according to the quantum machine instructions. For example, the controllers 106A may cause the signal hardware 104A to generate control signals that are delivered to the quantum processing unit 102A to execute the quantum machine instructions.

In some instances, the controllers 106A extract qubit state information from qubit readout signals, for example, to identify the quantum states of qubits in the quantum processing unit 102A or for other purposes. For example, the controllers may receive the qubit readout signals (e.g., in the form of analog waveforms) from the signal hardware 104A, digitize the qubit readout signals, and extract qubit state information from the digitized signals. In some cases, the controllers 106A compute measurement statistics based on qubit state information from multiple shots of a quantum program. For example, each shot may produce a bitstring representing qubit state measurements for a single execution of the quantum program, and a collection of bitstrings from multiple shots may be analyzed to compute quantum state probabilities.

In some implementations, the controllers 106A include one or more clocks that control the timing of operations. For example, operations performed by the controllers 106A may be scheduled for execution over a series of clock cycles, and clock signals from one or more clocks can be used to control the relative timing of each operation or groups of operations. In some implementations, the controllers 106A may include classical computer resources that perform some or all of the operations of the servers 108 described above. For example, the controllers 106A may operate a compiler to generate binary programs (e.g., full or partial binary programs) from source code; the controllers 106A may include an optimizer that performs classical computational tasks of a hybrid classical/quantum program; the controllers 106A may update binary programs (e.g., at runtime) to include new parameters based on an output of the optimizer, etc.

The other quantum computer system 103B and its components (e.g., the quantum processing unit 102B, the signal hardware 104B, and controllers 106B) can be implemented as described above with respect to the quantum computer system 103A; in some cases, the quantum computer system 103B and its components may be implemented or may operate in another manner.

In some implementations, the quantum computer systems 103A, 103B are disparate systems that provide distinct modalities of quantum computation. For example, the computer system 101 may include both an adiabatic quantum computer system and a gate-based quantum computer system. As another example, the computer system 101 may include a QPU sublattice-based quantum computer system and an ion trap-based quantum computer system. In such cases, the computer system 101 may utilize each quantum computing system according to the type of quantum program that is being executed.

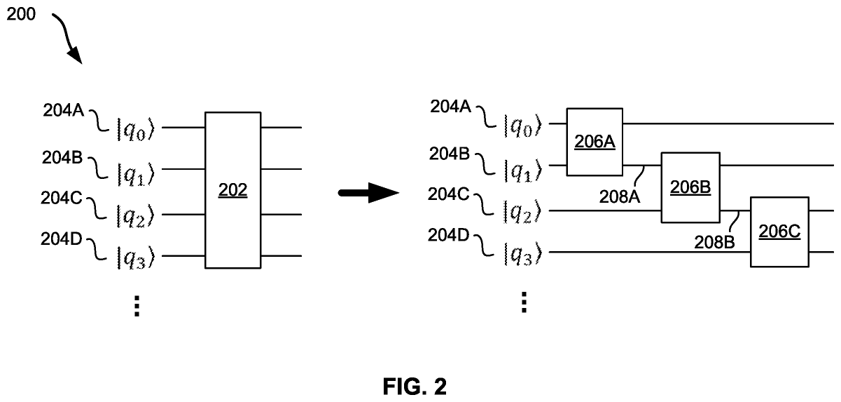

In some implementations, the computing system 101 including classical and quantum computing resources, at least a subset of which is used to evaluate quantum logic circuits subject to certain constraints. The computing system 101 receives a computer program including a quantum logic circuit (e.g., from the user device 110) and evaluate the quantum logic circuit by performing operations in the example processes 200, 300 and 500 in FIGS. 2, 3 and 5, or in another manner. The classical and quantum computing resources in the computing system 101 may further include a number of additional elements needed to execute the quantum logic circuits and communicate results, e.g. classical control hardware, interfaces to local or wide-area networks, or other elements.

In some implementations, the quantum logic circuit in the computer program is decomposed by operation of the computing system into quantum logic blocks which are simulated by classical computing resources or executed on quantum computing resources of the computing system 101. The computing system 101 further generate execution tasks configured to execute the quantum logic circuit on the hardware resources of the computing system 101. The execution tasks are then dispatched to different classical and quantum computing resources for execution. Output data from the classical and quantum computing resources are received and combined to produce an output of the computer program based on the output data.

In some instances, the quantum computing system 103A, 103B is a quantum computing resource, which may include a set of qubit devices. A set of quantum logic blocks in a quantum logic circuit can be applied to qubits defined by the set of qubit devices. In some implementations, quantum hardware resource metadata is used to specify properties of the quantum computing resources. For example, quantum hardware resource metadata may include error rate information and availability information associated with respective quantum computing resources. The error rate information can include, for example, an error rate of individual quantum logic gates, an average error rate for a set of quantum logic gates, and related information. In some cases, the error rate information includes gate fidelities or other information that can be used to compute an error per quantum operation. The availability information can include, for example, a number of qubits available on a computing resource; for instance, a resource that has N qubits available is capable of executing an N-qubit quantum logic circuit (a quantum logic circuit that is defined over N qubits). In some cases, the availability information may also indicate a time when a resource is available, a cost of using the resource, a location of the resource and related information. In some instances, quantum hardware resource metadata also includes a set of supported quantum logic gates. For example, the hardware resource metadata may include a library of native quantum logic gates that can be executed directly by a quantum computing resource.

In some instances, the classical processor 111 in the server 108, or one or more of the other resources 107, is available as a classical computing resource that can be used to execute quantum logic blocks from a quantum logic circuit. In some implementations, classical hardware resource metadata for the classical computing resources includes metadata indicating limitations on the size or complexity of quantum logic circuits that can be executed by the classical computing resource. The classical hardware resource metadata may also indicate a runtime for simulating quantum logic circuits of various sizes. The hardware resource metadata of classical and quantum computing resources can be pre-determined in a separate process, which can be stored in a memory (e.g., the memory 112 of the server 108) and accessed later (e.g., when determining a decomposition of a quantum logic circuit or at another time).

In some implementations, the hardware resource metadata can be used to identify which quantum logic circuits may be possibly executed, to estimate the corresponding runtime and associated error in the execution, or for another purpose. The hardware resource metadata can be also used in a decomposition process of the quantum logic circuit and for generating execution tasks that can be executed separately on distinct hardware resources.

In some implementations, a quantum computing resource includes one or more quantum processing units, and each of the quantum processing units includes multiple qubit devices. Each of the qubit devices can define a single bit of quantum information (a qubit). For example, each of the qubit devices may have two eigenstates that are used as computational basis states, and each qubit device can transition between its computational basis states or exist in an arbitrary superposition of its computational basis states. In some examples, the two lowest energy levels (e.g., the ground state |0 [symbol] and the first excited state |1 [symbol] ) of each qubit device are defined as a qubit and used as computational basis states for quantum computation. In some examples, higher energy levels (e.g., a second excited state |2 [symbol] or a third excited state |3 [symbol] ) are also defined by a qubit device, and may be used for quantum computation in some instances.

Qubits defined by respective qubit devices can be manipulated by control signals, or read by readout signals, generated by a control system (e.g., the control system 105). The qubit devices can be controlled individually, for example, by delivering control signals to the respective qubit devices. In some cases, the quantum processing unit includes readout devices that can detect the qubits of the qubit devices, for example, by interacting directly with the respective qubit devices.

In some examples, a qubit device, when implemented as a tunable qubit device which has a transition frequency that can be tuned, includes a quantum circuit loop (e.g., a SQUID loop). The quantum circuit loop receives a magnetic flux that tunes the transition frequency of the tunable qubit device. In some instances, the transition frequency can be tuned within a range of qubit operating frequencies. The quantum circuit loop may include two Josephson junctions, and the tunable qubit device may also include a shunt capacitor connected in parallel with each of the two Josephson junctions. In some examples, a transition frequency, which defines a qubit operating frequency of a tunable qubit device, is tunable, for example, by application of a magnetic flux. A qubit operating frequency of the tunable qubit device may be defined at least in part by Josephson energies of the two Josephson junctions, a capacitance of the shunt capacitor, and a magnetic flux threading the quantum circuit loop.

In some implementations, a coupler device, when implemented as a tunable coupler device, may receive control signals to enable electromagnetic coupling or decoupling between the qubit devices. When two or more qubit devices are coupled, the two or more qubit devices can be used to perform multi-qubit quantum logic gates in a quantum logic circuit.

FIG. 2 is a schematic diagram showing aspects of an example process 200 for decomposing an example quantum logic circuit 202. In some implementations, the example quantum logic circuit 202 includes a sequence of quantum logic operations applied on qubits defined by respective qubit devices 204 in one or more QPUs to perform a computer program. The computer program may correspond to a computational task, a hardware test, a quantum error correction procedure, a quantum state distillation procedure, or a combination of these and other types of operations. The quantum logic circuit 202 can be applied to transform the qubits and extract measurements representing the output of the quantum computation.

The quantum logic circuit 202 may include one or more single-qubit quantum logic gates, and one or more multi-qubit quantum logic gates applied on a subset of qubits defined by a respective subset of qubit devices. The quantum logic circuit 202 can be decomposed into multiple (k) quantum logic blocks 206 by performing a circuit decomposition process such that a subset of quantum logic operations in the quantum logic circuit 202 are grouped together in a single quantum logic block 206. A quantum logic circuit 200 may be decomposed in a different manner and resulting blocks from different decompositions may be different. The quantum logic circuit 200 after decomposition can be executed on a computing system, e.g., the computing system 101 as shown in FIG. 1 or in another manner. The example quantum logic circuit 200 may include additional or different features, and the components may be arranged as shown or in another manner.

In some implementations, decomposing a quantum logic circuit 202 into quantum logic blocks 206 provides the language and structure for considering concurrent execution of the quantum logic circuit, as each of the quantum logic blocks 206 contains a subset of the quantum logic operations in the quantum logic circuit 202 which can be run on a subset of quantum computing resources independently from one another.

As shown in FIG. 2, the example quantum logic circuit 200 includes quantum logic operations applied on a four-qubit system, e.g., qubits 204A, 204B, 204C, 204D. The example quantum logic circuit 200 is decomposed into three quantum logic blocks, e.g., a first quantum logic block 206A, a second quantum logic block 206B, and a third quantum logic block 206C. After decomposition, each of the quantum logic gates in the quantum logic circuit 200 is part of one of the three quantum logic blocks 206A, 206B, 206C.

In the example presented here, the quantum logic circuit 200 is expressed using a wire diagram as shown in FIG. 2. In certain instances, a quantum logic circuit may be described in another manner, for example, by a quantum instruction program, equivalently via tensor-network representation. When a quantum logic circuit is expressed using a quantum instruction program, the decomposition of the example quantum logic circuit 200 can be expressed using the following Quil program:

DECLARE ro BIT[2]

| | | |
|---|---|---|
| X | 0 | ; Block 1 |
| CNOT | 0 1 | ; Block 1 |
| H | 2 | ; Block 2 |
| Y | 0 | ; Block 1 |
| CNOT | 1 2 | ; Block 2 |
| RX(pi/2) | 2 | ; Block 2 |
| CZ | 2 3 | ; Block 3 |
| RX(pi/2) | 3 | ; Block 3 |
| MEASURE 2 ro | | |
| MEASURE 3 ro | | |

As defined by the example Quil program, the first quantum logic block 206A includes a first single-qubit Pauli gate (X) applied on a first qubit 204A defined by a first qubit device in a QPU, a first two-qubit controlled NOT gate (CNOT) applied on the first qubit 204A defined by the first qubit device and a second qubit 204B defined by a second qubit device, and a second single-qubit Pauli gate (Y) applied on the first qubit 204A defined by the first qubit device. The second quantum logic block 206B includes a Hadamard gate applied on a third qubit 204C defined by a third qubit device, a second two-qubit CNOT gate applied on the third qubit 204C defined by the third qubit device and the second qubit 204B defined by the second qubit device, and a first single-qubit rotation gate (Rₓ(π/2)) applied on the third qubit 204C defined by the third qubit device. The third quantum logic block 206C includes a two-qubit controlled-Z gate (Z) applied on a fourth qubit 204D defined by a fourth qubit device and the third qubit 204C defined by the third qubit device, and a second single-qubit rotation gate (Rₓ(π/2)) applied on the fourth qubit 204D defined by the fourth qubit device.

In some implementations, after decomposition, a quantum logic block 206 includes internal connections which connect the subset of quantum logic gates within the quantum logic block 206. Different quantum logic blocks 206 are connected to one another via external connections 208, connecting quantum logic gates from different quantum logic blocks. As shown in FIG. 2, the first quantum logic block 206A is coupled to the second quantum logic block 206B through a first external connection 208A; and the second quantum logic block 206B is coupled to the third quantum logic block 206C through a second external connection 208B. In the example shown here, the first quantum logic block 206A and the third quantum logic block 206C are not directly coupled to each other.

In some implementations, a subset of quantum logic operations in the same quantum logic block is assigned to the same index. The subset of quantum logic operations in the same quantum logic block form a connected quantum logic sub-circuit. When two or more quantum logic operations in the same quantum logic block involve a common qubit, then all the quantum logic operations in between the two or more quantum logic operations involving the common qubit are also grouped in the same quantum logic block. In the Quil program, the first single-qubit Pauli gate (X) and the second single-qubit Pauli gate (Y) are applied on the same qubit (e.g., the first qubit 204A). The first two-qubit controlled NOT gate (CNOT) residing between the first and second single-qubit Pauli gates is also grouped into the first quantum logic block 206A. Each of the quantum logic blocks decomposed from the quantum logic circuit includes an uninterrupted set of quantum logic operations. In some implementations, when no other quantum logic operations can be added to a quantum logic block, a quantum logic block is at its maximal.

In some implementations, a quantum logic block 206 generated by decomposing the quantum logic circuit (e.g., the quantum logic circuit 202) includes one or more execution tasks that operates on all qubits to which the larger quantum logic circuit is applied. For example, when a quantum logic circuit is configured for application to N qubits, each of the quantum logic blocks may be configured for application to M qubits. In the example shown in FIG. 2, each of the quantum logic blocks 206 is configured for application on a smaller subset of qubits, such that M is less than N. In certain instances, when a quantum logic circuit is decomposed, some or all of the quantum logic blocks may be configured for application to all qubits, such that M is equal to N.

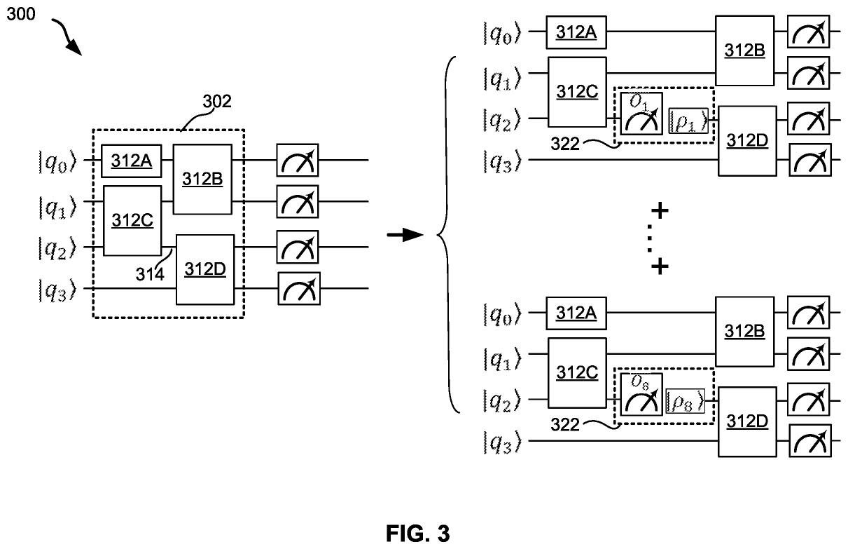

There are a number of techniques that can be used to treat external connections between quantum logic blocks after decomposition of a quantum logic circuit. One example technique is described in the publication entitled “Simulating Large Quantum Circuits on a Small Quantum Computer” by T. Peng, et al. (arXiv:1904.00102v2 [quantu-ph] 8 Dec. 2020), incorporated by reference in its entirety herein, certain aspects of which are summarized in FIG. 3.

FIG. 3 is a schematic diagram showing aspects of an example process 300 for cutting external connections between quantum logic blocks from performing a decomposition process on an example quantum logic circuit. A quantum logic circuit 302 including quantum logic operations is decomposed into four quantum logic blocks, e.g., a first quantum logic block 312A, a second quantum logic block, 312B, a third quantum logic block 312C, and a fourth quantum logic block 312D. Each of the quantum logic blocks 312A, 312B, 312C, 312D includes a subset of the quantum logic operations of the quantum logic circuit 302. Each of the quantum logic blocks 312A, 312B, 312C, 312D includes one or more single-qubit quantum logic gates, and one or more multi-qubit quantum logic gates. In some implementations, each of the quantum logic blocks 312A, 312B, 312C, 312D may be implemented as the quantum logic block 206 as shown in FIG. 2 or in another manner. The quantum logic circuit 302 is performed on a four-qubit system. All output qubits are measured in the computational basis. In some instances, a classical post-processing function (e.g., f: {0, 1}ⁿ→[−1, 1]) can be applied to the measurement outcomes.

As shown in FIG. 3, the second quantum logic block 312B is connected to each of the first and third quantum logic blocks 312A, 312C through respective external connections; and the fourth quantum logic block 312D is connected to the third quantum logic block 312C via a respective external connection. As shown in the example process 300, the respective external connections can be “cut”. Using the external connection 314 between the third and the fourth quantum logic blocks 312C, 312D as an example, the external connection 314 can be cut and replaced by a measurement and state preparation pair 322. In some implementations, evaluating the quantum logic circuit 302 is equivalent to evaluating the quantum logic circuit 302 with the external connection 314 replaced by a measurement and state preparation pair 322 at different values, e.g., (|ρ₁ [symbol] , O₁), . . . , and (|ρ₈ [symbol] , O₈). For example, an identity, e.g., E_{C}[f(y)], the mean value of a bitstring function f with respect to the probability distribution associated to the quantum logic circuit 302 can be mathematically expressed as:

$${E}_{C} [ f ( y ) ] = {\sum }_{i = 1}^{8} {c}_{i} {E}_{{C}_{i}} [ f ( y ) ] \qquad ( 1 )$$

where cᵢ are known constants, and Cᵢ represents the quantum logic circuit with the external connection 314 replaced by a measurement and state preparation pair. The measurement Oᵢ is associated to the third quantum logic block 312C and the state preparation |ρᵢ [symbol] is associated with the fourth quantum logic block 312D. Example values of parameters in the identity E_{C}[f(y)] are shown below

$$\begin{matrix}{O}_{1} = I , {ρ}_{1} = \vert 0 〉 〈 0 \vert , {c}_{1} = + 1 / 2 , \\ {O}_{2} = I , {ρ}_{2} = \vert 1 〉 〈 1 \vert , {c}_{2} = + 1 / 2 , \\ {O}_{3} = X , {ρ}_{3} = \vert + 〉 〈 + \vert , {c}_{3} = + 1 / 2 , \\ {O}_{4} = X , {ρ}_{4} = \vert - 〉 〈 - \vert , {c}_{4} = - 1 / 2 , \\ {O}_{5} = Y , {ρ}_{5} = \vert + i 〉 〈 + i \vert , {c}_{5} = + 1 / 2 , \\ {O}_{6} = Y , {ρ}_{6} = \vert - i 〉 〈 - i \vert , {c}_{6} = - 1 / 2 , \\ {O}_{7} = Z , {ρ}_{7} = \vert 0 〉 〈 0 \vert , {c}_{7} = + 1 / 2 , \\ {O}_{8} = Z , {ρ}_{8} = \vert 1 〉 〈 1 \vert , {c}_{8} = - 1 / 2 ,\end{matrix} \qquad ( 2 )$$

As shown in the example process 300, external connections between quantum logic blocks can be “cut” and replaced by state preparation and measurement pairs. Evaluating each quantum logic circuit Cᵢ results in not just a bitstring y but also a value σ∈{−1,1} for the Pauli measurement Oᵢ.

When a decomposed quantum logic circuit includes n external connections, expanding each of these using the identity gives:

$${E}_{C} [ f ( y ) ] = {\sum }_{s ∈ {\{ 1 , 2 , … 8 \}}^{n}} {c}_{s} {E}_{{C}_{s}} [ f ( y ) ] \qquad ( 3 )$$

where s=(s₁, . . . , sₙ) now indicates a tuple of n indices, each in the range {1,2, . . . , 8}, cₛ=Πⱼ₌₁ⁿcₛ_{ⱼ} is a product of terms, each of which is ±1/2Cₛ denotes the circuit obtained by replacing external connections j (j∈[1, n]) with measurement and state preparation pairs 322, e.g., Oₛ_{ⱼ}−|ρₛ_{ⱼ} [symbol] pairs.

In some implementations, the identity E_{C}[f (y)] shown above can be evaluated by selecting s∈{1, . . . , 8}ⁿ uniformly at random, and forming the quantum logic circuit Cₛ evaluating the quantum logic circuit Cₛ for a single shot, resulting in a bitstring y and Pauli measurement outcomes σ∈{−1,1}ⁿ forming the product 8ⁿf(y)cₛΠⱼ₌₁ⁿσᵢwhich is an unbiased estimate for E_{C}[f (y)]. This process can be repeated for N times and the results from the N repetitions can be averaged, obtaining a Monte Carlo estimate, which can be expressed as:

$${E}_{C} [ f ( y ) ] \approx \frac{1}{N} {\sum }_{l = 1}^{N} {8}^{n} f ( {y}^{l} ) {c}_{s}^{l} {\prod }_{j = 1}^{n} {σ}_{i}^{l} \qquad ( 4 )$$

where the superscript l(l∈[1,N])) denotes which d of the above steps is being considered.

The number of iterations (N) controls the final error in the Monte Carlo estimate of the identity E_{C}[f (y)] in Equation (4). In particular, assuming ideal hardware (e.g., there is no error in computing the product 8ⁿf(y)cₛΠⱼ₌₁ⁿσᵢ), the error decays like

$$O ( \frac{1}{\sqrt{N}} ) .$$

In some instances, for adequate bounds on the Monte Carlo error, an exponential (in n) number of iterations is required. In some implementations, the number of iterations (N) is determined based on the stopping criterion (e.g., an error bound for the output of the computer program). In some instances, the number of iterations can be determined in another manner.

In some instances, the quantum logic circuit Cₛ can be evaluated by evaluating each quantum logic block in sequence, with each bit values {yᵢ} for a subset of the qubits, and Pauli outcomes for those Pauli measurements associated with the quantum logic block combining individual bit values to obtain y, and combining individual Pauli measurement outcomes to obtain σ. In some instances, when combining individual bit values to obtain y or combining individual Pauli measurement outcomes to obtain σ, strings and arrays in the outer loop of a simulation software are concatenated.

A system for execution of a quantum logic circuit via quantum logic block decomposition, and consider specifically those computations which may be expressed by means of a “scatter, gather, update” algorithm, such as:

```
input: circuit
output: estimate
preprocess circuit
initialize estimate
do {
  // “scatter” tasks/subproblems
  generate tasks/subproblems from circuit
  execute tasks/subproblems, yielding result data
  // “gather” results
  combine result data
  // “update” algorithm state
  update estimate from combined results
} while (stopping condition not met)
```

In some implementations, during a “scattering” operation, a quantum logic circuit is decomposed into execution tasks/sub-problems, e.g., quantum logic blocks. For example, a quantum logic circuit is pre-processed by determining a quantum logic block decomposition. Execution tasks or sub-problems are generated from the quantum logic circuit. The execution tasks or sub-problems can be executed; and results can be generated. For example, the estimate is initialized to 0. For each iteration, one sub-problem represents a quantum logic block. The sub-problems decomposed from the quantum logic circuit involve random choices for the Pauli measurement and state preparations. Execution of the sub-problems is sequential using a classical simulator. In some implementations, during a “gathering” operation, result data (bitstrings and Pauli measurement results) are combined via string and array concatenation. In some implementations, during an “updating” operation, the estimated update for the current iteration involves computing 8ⁿf(y)cₛΠⱼ₌₁ⁿσᵢ followed by combining with the previous estimate for obtaining (on the Nth iteration) the sum

$$\frac{1}{N} {\sum }_{l = 1}^{N} {8}^{n} f ( {y}^{l} ) {c}_{s}^{l} {\prod }_{j = 1}^{n} {σ}_{i}^{l} .$$

In some implementations, the “scatter, gather, update” algorithm presented here includes a stopping condition,

$$e . g . , N > \frac{{2}^{4 n + 1}}{{ϵ}^{2}} ,$$

where N is the number of iterations, n is the number of external connections, and ϵ is a stopping criterion (e.g., a user-specified “Monte Carlo error tolerance”).

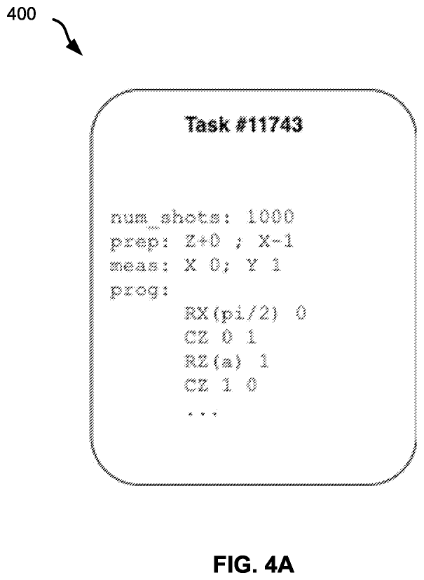

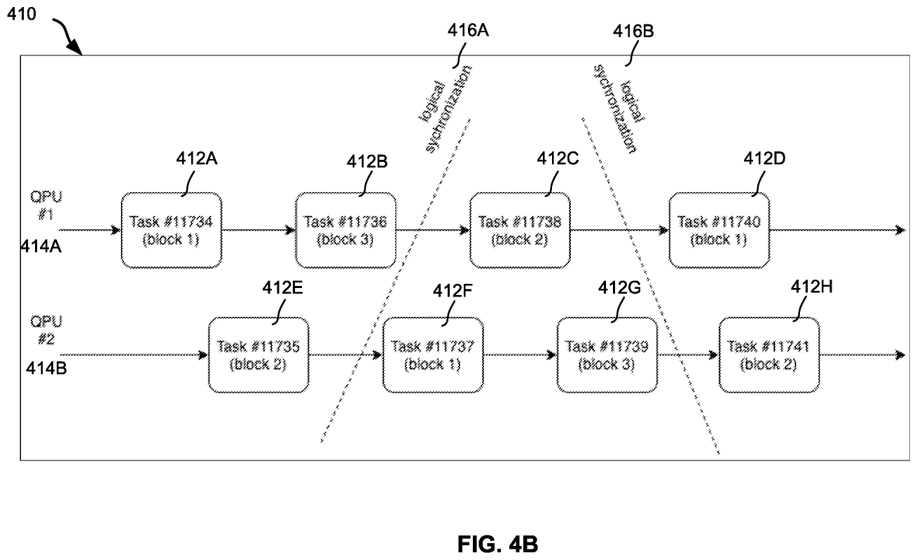

In some implementations, to perform the “scatter, gather, update” algorithm, mechanisms for performing the operations in the algorithm are utilized, including a mechanism for producing execution tasks (e.g., the example execution tasks as shown in FIGS. 4A-4B) from quantum logic blocks, a mechanism for combining results from the execution tasks, a mechanism for updating a numeric estimate, a deterministic expression of a stopping criterion, or another mechanism. In some instances, each of the mechanisms may be a library subroutine, a user-supplied procedure, a hard-coded program, or in another format. In some instances, stopping criteria may be fully resolved in advance. In other words, a number of iterations in the “scatter, gather, update” algorithm may be predetermined.

FIG. 4A is a schematic diagram showing aspects of an example execution task 400. An execution task is an individual unit of computational work. In some implementations, an execution task includes information about a quantum logic sub-circuit to be executed (e.g. a Quil program), information about state preparation and measurement, and additional metadata such as the number of shots, readout calibration or symmetrization, information about hardware-specific timing, or another type of information. As shown in FIG. 4A, the example execution task 400 is expressed textually. In some instances, the example execution task 400 can be stored in a preprocessed binary format, allowing for reduced execution time.

As shown in FIG. 4A, the execution task 400 (e.g., Task #11743) specifies the associated quantum logic block, the number of iterations, state preparation-measurement pairs. The associated quantum logic block includes a subset of quantum logic operations for application on designated qubits defined by designated qubit devices with a particular order and sequence, e.g., a RX(π/2) gate applied on qubit 0, followed by a first CZ gate applied on qubits 0 and 1, followed by a RZ(a) gate applied on qubit 1, and followed by a second CZ applied on qubits 1 and 0.

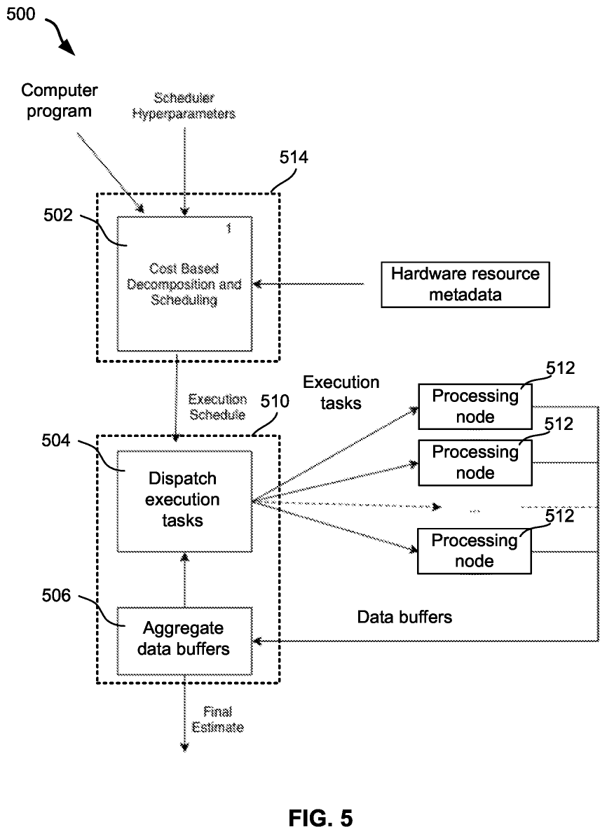

In some implementations, the execution task 400 can be generated by a mechanism during a “scattering” process as part of a “scatter, gather, update” algorithm. For example, the execution task 400 can be generated from a quantum logic block generated by decomposing a quantum logic circuit (e.g., the quantum logic circuit 200 as shown in FIG. 2 or in another manner) during the operation 502 in the example process 500 shown in FIG. 5 or in another manner. The total number of execution tasks produced by the mechanism is Nk, where N is the total number of iterations of the algorithm, and k is the number of quantum logic blocks generated by the scattering process.

In some implementations, evaluation of the execution tasks generated by the algorithm are logically dependent. In some instances, as the evaluations require the use of classical or quantum computing resources in processing nodes, evaluations of the execution tasks may be coordinated to form an execution schedule. In some implementations, an execution schedule is an assignment of execution tasks to classical or quantum computing resources (e.g., processing nodes), together with a logical or dependency ordering.

FIG. 4B is a schematic diagram showing aspects of an example execution schedule 410. An execution schedule includes information about physical hardware assignment and logical data dependencies. In some instances, an execution schedule may include other information. An execution schedule is associated with a decomposed quantum logic circuit. As shown in FIG. 4B, the example execution schedule 410 corresponds to the quantum logic circuit 200 shown in FIG. 2, which is decomposed into three quantum logic blocks 206. Each of the three quantum logic blocks decomposed from the quantum logic circuit 200 corresponds to an execution task 412. Particularly, execution tasks 412A, 412D, 412F are generated according to the first quantum logic block 206A of the quantum logic circuit 200; execution tasks 412C, 412E, 412H are generated according to the second quantum logic block 206B of the quantum logic circuit 200; and execution tasks 412B, 412G are generated according to the third quantum logic block 206C of the quantum logic circuit 200. As shown in FIG. 4B, the example execution schedule 410 is generated with respect to a hypothetical pair of QPUs (e.g., QPU 414A and QPU 414B). As shown in FIG. 4B, each of the QPUs 414A, 414B is capable of executing execution tasks associated with any quantum logic blocks 206A, 206B, 206C as shown in FIG. 2. In the example shown in FIG. 4B, the quantum logic blocks are scheduled in a “leapfrog” fashion, so that each QPU is averaging 1.5 quantum logic blocks per cycle.

In the example shown in FIG. 4B, the QPUs generate output data by executing the execution tasks 412, and the output data from the QPUs are combined (e.g., at synchronization points) to produce an output of the execution schedule 410. In some implementations, the execution schedule 410 represents the totality of execution tasks to be executed (unless errors or hardware reconfigurations require an update). Within an execution schedule corresponding to N iterations of a “scatter, gather, update” algorithm, there may be N logical synchronization points 416A, 416B, which are divisions of the execution schedule 410 indicating a point at which sufficient execution tasks have been completed to update the estimated value of the identity (e.g., E_{C}[f(y)] in Equation (4)). As shown in FIG. 4B, the example execution schedule 410 includes two logical synchronization points 416. Between the two logical synchronization points 416, the task 412C is executed on the first QPU 414A and the tasks 412F and 412G are executed on the second QPU 414B. In some instances, a requirement for logical synchronization is that all quantum logic blocks within the quantum logic circuit have been evaluated at least once. In certain instances, this requirement may not place any physical requirements on the timing or execution of a schedule under normal conditions, but rather are required for error recovery or scenarios, for example, where an additional quantum computing resource (e.g., the processing nodes 512 as shown in FIG. 5) is introduced while an execution schedule is being executed.

FIG. 5 is a flow chart showing aspects of an example process 500. The example process 500 can be performed on a computing system with heterogeneous hardware resources configured in a cluster architecture. The computing system includes a cluster server 510, processing nodes 512, and a scheduler module 514. In some implementations, the cluster server 510 and the scheduler module 514 may be implemented as the servers 108, the quantum computing system 103, or other resources 107 in the computing system 101 in FIG. 1. In some instances, the computing system may include a set of distributed servers. The scheduler module 514 may be part of the cluster server 510, co-located with the cluster server 510, or may exist in separate hardware.

In some implementations, the computing system in which operations of the example process 500 are executed includes classical computing resources and quantum computing resources. In some implementations, the processing nodes 512 include at least a subset of the classical computing resources and at least a subset of the quantum computing resources. In some instances, a processing node 512 includes a classical computing interface (e.g. rack host, control hardware, or workstation) to one or more quantum computing resources or classical computing resources. Each processing node 512 is capable of receiving a subset of execution tasks generated by the cluster server 510, compiling the execution tasks as needed, evaluating the execution tasks, and then returning output data (e.g., a data buffer) encoding the results back to the cluster server 510. For example, the processing nodes 512 includes at least one processing node which includes a QPU that uses qubit devices to process a subset of the execution tasks, and at least one processing node which includes a classical processor (e.g., CPU or GPU) operating as a quantum virtual machine (QVM) to process or simulate a second subset of the execution tasks. In some instances, the processing nodes 512 may be implemented as the quantum computing system 103, the classical processors 111, or other resources 107 of the computing system 101 in FIG. 1.

In some implementations, the processing nodes 512 are communicably coupled to the cluster server 510, for example, by a high-speed memory bus, a local area network (LAN), wide area network (WAN), or another connection. In some implementations, the cluster server 510 is configured to manage hardware resources of, to dispatch execution tasks to, and to coordinate results from the processing nodes 512. In some implementations, the scheduler module 514 is configured to perform the decomposition of the quantum logic circuit, to generate execution tasks according to quantum logic blocks generated from the decomposition, and to produce the execution schedule for executing the execution tasks. The example process 500 may include additional or different operations, including operations performed by additional or different components, and the operations may be performed in the order shown or in another order. In some cases, operations in the example process 500 can be combined, iterated or otherwise repeated, or performed in another manner.

In some implementations, the example process 500 is used to evaluate a quantum logic circuit according to its computing resources. The methods and systems allow for the evaluation of a quantum logic circuit using any particular hardware resource and allow the evaluation of a single quantum logic circuit using computing resources in tandem.

At 502, by operation of the scheduler module 514, a decomposition process of a quantum logic circuit is performed; and an execution schedule is generated. In some implementations, prior to the decomposition process of the quantum logic circuit and generation of the execution schedule, the scheduler module 514 obtains a computer program for execution, for example, from a user device. In some implementations, the computer program includes a quantum logic circuit which includes quantum logic operations. The quantum logic circuit may be implemented as the quantum logic circuit 202, 302 in FIGS. 2 and 3 or in another manner.

In some implementations, the scheduler module 514 also obtains a set of schedular hyperparameters associated with the requested execution of the computer program, from the same user device, a different user device, another component within the computing system, or in another manner. In some implementations, the scheduler hyperparameters includes a stopping criterion (e.g., an error bound for the output of the computer program) for the execution of the computer program, a cost function hyperparameter, or other parameters.

In some implementations, the scheduler module 514 further obtains hardware resource metadata specifying properties of the processing nodes 512 in the computing system, e.g., a number of qubits available on the respective processing nodes 512; timing information of the classical and quantum computing resources of the processing nodes 512, a set of supported quantum logic gates and their gate fidelities, error rate information and availability information of the respective processing nodes 512, and other properties. In some instances, the hardware resource metadata may include metadata specifying properties of processing nodes 512 including classical computing resources; for example, classical hardware resource metadata may specify the circuit size or complexity that can be executed by a classical processing node and related information. In some implementations, the hardware resource metadata is used by the scheduler module 514 in processes of decomposing the quantum logic circuit and generating execution tasks.

In some instances, a quantum logic block from a decomposition of a quantum logic circuit may not be able to be executed on any available quantum computing resource. For example, when a number of qubits involved in a quantum logic block exceed the capacity of any available QPU or QVM. In some implementations, hardware resource metadata can be used to decompose a quantum logic circuit such that every single quantum logic block from the decomposition satisfies the hardware constraints of at least one quantum computing resource, e.g., after compilation or some other semantic-preserving transformation.

In some implementations, compatible decompositions may be used to translate a quantum logic circuit into execution tasks executable on at least one quantum computing resource. For a given quantum logic circuit C and a given resource set R, there may be multiple different compatible decompositions. In some instances, a compatible decomposition process is also a “balanced” decomposition process, e.g., corresponding execution tasks are distributed evenly to hardware resources (e.g., classical and quantum computing resources) in the resource set R. In some instances, a compatible decomposition process is also “NISQ-friendly”, e.g., quantum logic blocks are so long that QPU infidelity dominates. In some instance, a compatible decomposition process may also produce a minimal number of external connections and thus reduce the computational complexity for estimating the identity E_{C}[f(y)].

In order to improve the properties jointly, a number of heuristics may be introduced, e.g., a cost function defined on decompositions which may be the target of optimization. In some implementations, a cost function is expressed as below:

F(B; λ)=T·cⁿ+λ·β^{m} (5)

where B represents a decomposition of a quantum logic circuit C into k quantum logic blocks; n is the number of external connections in the decomposition B; c is an algorithm-specific constant indicating the number of execution tasks associated with a single external connection (e.g. c=8 as shown in FIG. 3); m is the maximum number of quantum logic operations executed in any quantum logic block; T is an estimate for the amount of work needed to execute all k quantum logic blocks across the resource set R; β is the average error per quantum operation; λ is a cost function hyperparameter which specifies a weighting of the error rate (e.g., fidelity) relative to the runtime. In some instances, T=mk/r, where r is the average number of hardware resources. In some instances, the average error per quantum operation β in the cost function of Equation (5) can be determined based on error rate information of the hardware resource metadata or can be included as part of the error rate information of the hardware resource metadata obtained by the scheduler module 514. In some instances, the average number of hardware resources r in the cost function of Equation (5) can be determined based on availability information of the hardware resource metadata or can be included as part of the availability information of the hardware resource metadata obtained by the schedular module 514.

The example cost function F in Equation (5) includes a first component (T·cⁿ) associated with the runtime of a set of quantum logic blocks specified by the decomposition B, and a second component (β^{m}) associated with the error rate of the set of quantum logic blocks. The first component or the second component (or both) can be formulated in another manner, for example, to combine the variables in another form or to account for other factors. The example cost function F in Equation (5) includes a cost function hyperparameter λ that specifies a weighting of the second component relative to the first component. The hyperparameter can also be used in the cost function in another manner; for example, it can be applied to the first or second component in another form. In some cases, the cost function F used in an optimization process to determine a decomposition of a quantum logic circuit. In some implementations, distinct values of the cost function hyperparameter (and potentially other hyperparameters) are provided for multiple requested executions of a computer program. As such, the optimization process may determine distinct decompositions for the requested executions, based on the distinct values of the cost function hyperparameter provided for each requested execution.

In some implementations, the cost function F in Equation (5) is defined over compatible decompositions of a quantum logic circuit, and hence minimizing F represents a non-trivial combinatorial optimization problem. Nonetheless, a number of heuristics may be used to find a compatible decomposition, such as greedy algorithms, convex relaxation techniques, stochastic search, via integer linear programming formulations, or in another manner. In certain examples, the cost function may be constructed in a different form to make a tradeoff between implied runtimes and error rates associated with respective sets of quantum logic block. The cost function for the respective sets of quantum logic blocks is evaluated based on the runtimes and error rates associated with the respective sets of quantum logic blocks. In some implementations, the runtimes and the error rates are determined based on the error rate information and the availability information in the hardware resource metadata.

In some implementations, after performing the decomposition process on the quantum logic circuit of the received computer program, the scheduler module 514 is configured to generate execution tasks from the quantum logic blocks. In some implementations, the execution tasks are generated based on the scheduler hyperparameters and the hardware resource metadata of the processing nodes 512. For example, the execution tasks are configured to be applied to a number of qubits defined by a number of qubit devices that are indicated as available in the availability information of the hardware resource metadata. In some implementations, the execution blocks are generated by performing a wire cutting process (e.g., the example process 300 in FIG. 3) in which external connections between any two quantum logic blocks are replaced by measurement and state preparation pairs. In some instances, the execution blocks may be generated in another manner. Each of the execution tasks (e.g., the example execution task 400 shown in FIG. 4A) specifies an associated quantum logic block which includes a sequence of quantum logic operations, a number of iterations, and values of measurement and state preparation pairs. In some implementations, the stopping criterion in the scheduler hyperparameters is used by the scheduler module 514 to determine the number of iterations N. For example, the number of iterations Nis determined when the stopping criterion (e.g., the Monte Carlo error bound of an output of the computer program) is satisfied.

In some implementations, the scheduler module 514 is configured to generate an execution schedule for the execution tasks, e.g., by aggregating the execution tasks based on the hardware resource metadata. The execution schedule expresses a sequence of execution tasks to be performed for each processing node 512. In some implementations, an execution schedule includes logical synchronization points, which are time points in the execution schedule when data buffers iteratively received from processing nodes 512 are combined according to the execution schedule. In some instances, the logical synchronization points can be used for other purposes. In some implementations, the scheduler module 514 is configured to transfer the generated execution schedule to the cluster server 510.

At 504, execution tasks are dispatched to the processing nodes 512 for execution. When an execution task is dispatched to a processing node, the execution task is sent to the processing node in a manner that causes the processing node to execute the execution task. In some implementations, the execution tasks are dispatched to the processing nodes 512 by the cluster server 510 according to the received execution schedule from the scheduler module 514. In some implementations, the execution tasks are dispatched to the respective processing node 512 based on the hardware resource metadata. In response to the number of the execution tasks in the execution schedule exceeding the number of processing nodes 512 in the computing system and when the time required to execute the execution tasks varies, execution tasks may be dispatched to processing nodes 512 in an asynchronous fashion in operation according to the execution schedule. For example, when the number of execution tasks exceeds the number of processing nodes, a first portion of the execution schedule (e.g., a first subset of the execution tasks) are dispatched to the processing nodes 512 during a first time period; and a second distinct portion of the execution schedule (e.g., a second subset of the execution tasks) are dispatched to the processing nodes 512 during a one or more later time periods.

After receiving the execution tasks, each of the processing nodes 512 execute the received execution tasks consistent with the execution schedule. In some instances, an execution task may also be executed on hardware resources associated with the processing node 512 (e.g., classical or quantum computing resources), or elsewhere. Upon execution of an execution task, a processing node 512 constructs a data buffer as an intermediate output consisting of measured bitstring values, Pauli measurement outcomes, runtime metadata (e.g. error information, execution duration, and etc.), and submits the data buffer back to the cluster server 510.

At 506, the data buffers associated with the execution tasks are received from at least a subset of the processing nodes 512 and combined by the cluster server 510. At every logical synchronization point (e.g., the logical synchronization points 416A, 416B as shown in FIG. 4B) in the execution schedule, the cluster server 510 iteratively updates the quantity (e.g., E_{C}[f (y)]) with the combined data buffer of the completed execution tasks from at least a subset of the processing nodes 512. When the cluster server 510 receives the data buffers from the processing nodes 512, it may dispatch new execution tasks to the respective processing nodes 512 (operations 504, and 506 are performed in an iterative manner). When there are no execution tasks remaining for one or more processing nodes 512 while certain execution tasks are being executed on one or more other processing nodes 512, the cluster server 510 may wait until all the execution tasks are executed, and the execution schedule is completed. In this case, the data buffers may be fully combined at their respective logical synchronization points, and the estimated value of the identity can be fully updated, the cluster server 510 produces an output of the computer program (for example, a final estimated value of the identity to the user).

In some implementations, during an execution of a computer program utilizing a large number of hardware resources, changes to the hardware resources (e.g., to the resource set R) may occur. In some instances, a change to the hardware resources for execution the execution tasks includes a failure of a hardware resource which renders it incapable of executing execution tasks. For example, a failure of a hardware resource may be a systematic failure caused by an expiration of calibrated device parameters, a helium leak, a segmentation fault on the control hardware, a network outage, or another type of failure. In some instances, a change to the hardware resources for executing the execution tasks may include an addition of new hardware resources. For example, a QPU which has completed a retune/recalibration process can become available and can be further used for processing execution tasks; a QVM object can be provisioned via a cloud service provider, or hardware resources which are previously used during the performance of another job can be now completed and become available.

In other words, the resource set R for the requested execution of the computer program may vary, for example changed to a new resource set R′, during the execution of a quantum logic circuit. In this case, the cluster server 510 can be notified of the change in the resource set R, e.g., by receiving an explicit message from a processing node 512 or by the triggering of a timeout. The cluster server 510 identifies the last logical synchronization point in the execution schedule, and truncates all subsequent execution tasks in the execution schedule at least for the changed hardware resources or changed processing nodes after the last logical synchronization point. Data buffers associated with the executed tasks after the last logical synchronization point (e.g. bitstring and Pauli measurement results) can be discarded. In some implementations, a new circuit decomposition and a new execution schedule are requested by the scheduler module 514, compatible with the new resource set R′, with capability of producing N−N′ logical synchronization points, where N is the total number of logical synchronization points in the original schedule based on the original resource set R, and N′ is the number of logical synchronization points completed before rollback. In some implementations, the truncated execution schedule is augmented with the new execution schedule. Execution of the computer program continues with the augmented new execution schedule, which includes new execution tasks associated with at least a subset of the processing nodes which do not involve changes to the hardware resources.

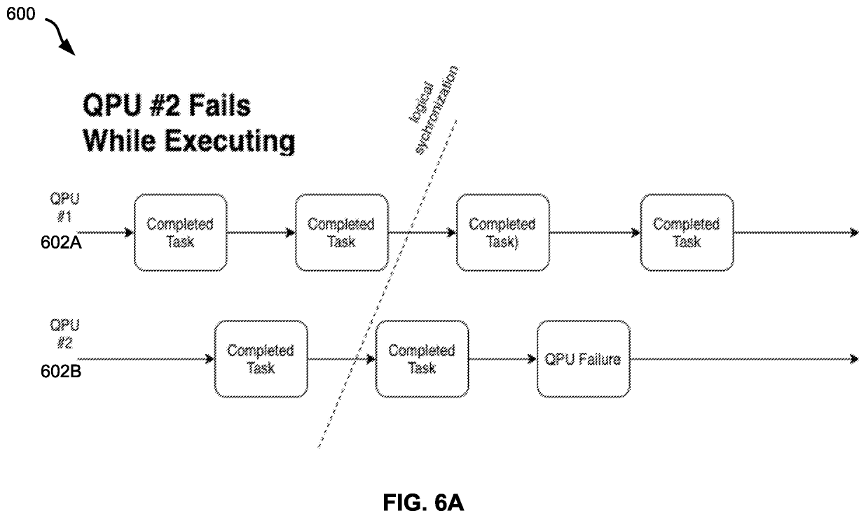

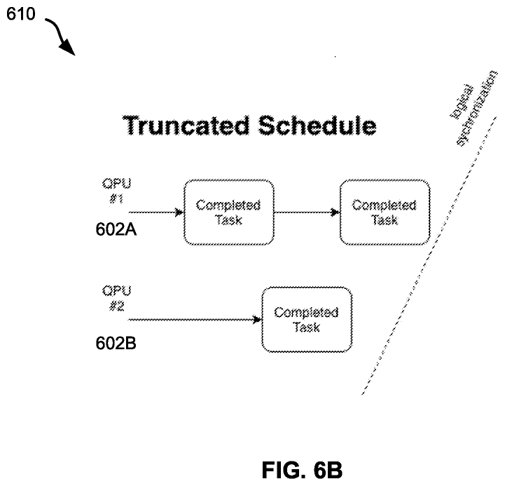

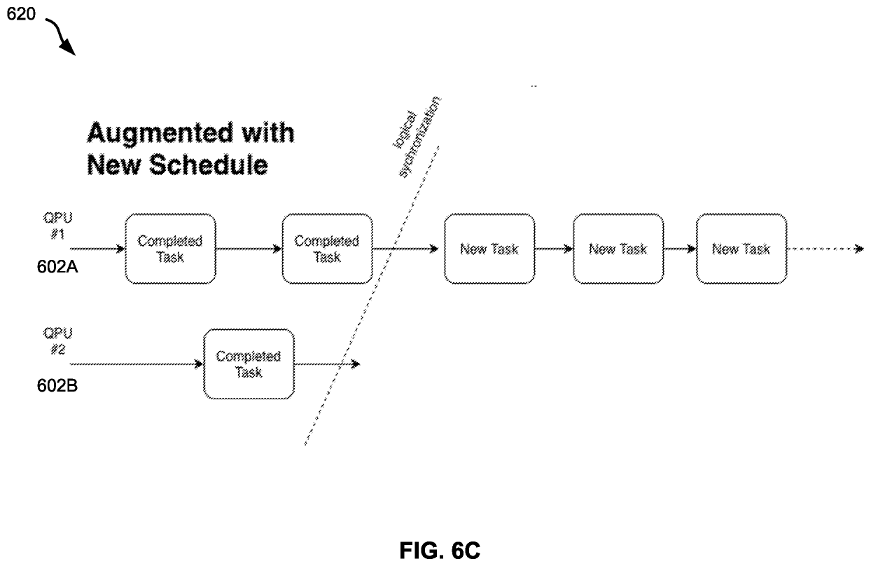

FIGS. 6A-6C are schematic diagrams showing aspects of example execution schedules 600, 610, 620 when a failure of a processing node occurs. Each of the example execution schedules 600, 610, 620 associated with a decomposed quantum logic circuit, e.g., the decomposed quantum logic circuit 200 shown in FIG. 2 with respect to a hypothetical pair of QPUs (e.g., QPU 602A and QPU 602B). Each of the execution schedules 600, 610, 620 includes multiple execution tasks 602.

When a quantum computing resource (e.g., QPU 602B) for executing a subset of execution tasks in an execution schedule 600 in FIG. 6A is failed, a cluster server (e.g., the cluster server 510 of the computing system in FIG. 5) is notified. After receiving a notification of a failure of a QPU (e.g., QPU 602B), the example execution schedule 600 is truncated, for example, by operation of the cluster server. As shown in FIG. 6B, the example execution schedule 610 is truncated at a logical synchronization point (e.g. the nearest logical synchronization point prior to the time point of the failure of the QPU 602B) or in another manner. After being truncated, the example execution schedule 620 shown in FIG. 6C can be augmented with a new execution schedule for the reduced hardware resources (e.g., for the QPU 602A only).

In some implementations, while a first execution schedule including a first set of execution tasks associated with a first quantum logic circuit is currently being executed on the computing system utilizing all hardware resources, a second execution schedule including a second set of execution tasks associated with a second quantum logic circuit is submitted to the cluster server of the computing system. The cluster server is configured to truncate the first execution schedule, to split the set of resources R into a first subset of hardware resources R′ and a second subset of hardware resources R″, and to schedule and execute remaining execution tasks in the first execution schedule on the first subset of hardware resources R′; and schedule and execute the second execution schedule on the second subset of hardware resources R″. In some instances, the first subset of hardware resources includes a first subset of processing nodes; and the second subset of hardware resources includes a second distinct subset of processing nodes such that the execution of the first and second execution schedule on the computing system can be performed concurrently, simultaneously or in parallel. In some instances, the first and second subsets of hardware resources may share hardware resources and execution of execution tasks on the shared hardware resources may be executed asynchronously.

Some of the subject matter and operations described in this specification can be implemented in digital electronic circuitry, or in computer software, firmware, or hardware, including the structures disclosed in this specification and their structural equivalents, or in combinations of one or more of them. Some of the subject matter described in this specification can be implemented as one or more computer programs, i.e., one or more modules of computer program instructions, encoded on a computer storage medium for execution by, or to control the operation of, data-processing apparatus. A computer storage medium can be, or can be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media.

Some of the operations described in this specification can be implemented as operations performed by a data processing apparatus on data stored on one or more computer-readable storage devices or received from other sources.

The term “data-processing apparatus” encompasses all kinds of apparatus, devices, and machines for processing data, including by way of example a programmable processor, a computer, a system on a chip, or multiple ones, or combinations, of the foregoing. The apparatus can include special purpose logic circuitry, e.g., an FPGA (field programmable gate array) or an ASIC (application specific integrated circuit). The apparatus can also include, in addition to hardware, code that creates an execution environment for the computer program in question, e.g., code that constitutes processor firmware, a protocol stack, a database management system, an operating system, a cross-platform runtime environment, a virtual machine, or a combination of one or more of them.

A computer program (also known as a program, software, software application, script, or code) can be written in any form of programming language, including compiled or interpreted languages, declarative or procedural languages, and it can be deployed in any form, including as a stand-alone program or as a module, component, subroutine, object, or other unit suitable for use in a computing environment. A computer program may, but need not, correspond to a file in a file system. A program can be stored in a portion of a file that holds other programs or data (e.g., one or more scripts stored in a markup language document), in a single file dedicated to the program, or in multiple coordinated files (e.g., files that store one or more modules, sub programs, or portions of code). A computer program can be deployed to be executed on one computer or on multiple computers that are located at one site or distributed across multiple sites and interconnected by a communication network.

Some of the processes and logic flows described in this specification can be performed by one or more programmable processors executing one or more computer programs to perform actions by operating on input data and generating output. The processes and logic flows can also be performed by, and apparatus can also be implemented as, special purpose logic circuitry, e.g., an FPGA (field programmable gate array) or an ASIC (application specific integrated circuit).

In a general aspect, a quantum logic circuit is executed on multiple processing nodes, for example, in a quantum or hybrid computing system.

In a first example, a method of operating a computing system including quantum computing resources includes obtaining a computer program, the computer program including a quantum logic circuit, the quantum logic circuit including quantum logic operations; obtaining hardware resource metadata specifying properties of a plurality of processing nodes in the computing system, the plurality of processing nodes including at least a subset of the quantum computing resources, the hardware resource metadata including error rate information and availability information for the respective processing nodes; generating a plurality of execution tasks configured to execute the quantum logic circuit on the plurality of processing nodes, wherein each of the plurality of execution tasks includes a respective subset of the quantum logic operations, and the plurality of execution tasks are generated based on the hardware resource metadata; dispatching the plurality of execution tasks to the plurality of processing nodes; receiving output data generated by the plurality of processing nodes executing the plurality of execution tasks; and producing an output of the computer program based on the output data.

Implementations of the first example may include one or more of the following features. The quantum logic circuit is configured to be applied to a plurality of qubits. Each of the plurality of execution tasks includes a quantum logic block which includes a respective subset of the quantum logic operations. Each quantum logic block is configured to be applied to a subset of the plurality of qubits. The method includes obtaining a hyperparameter associated with a requested execution of the computer program; and generating the plurality of execution tasks based on the hyperparameter and the hardware resource metadata. generating the plurality of execution tasks includes determining the quantum logic blocks based on the hyperparameter in a cost function. The method further includes determining a runtime of a set of quantum logic blocks based on the availability information; and determining an error rate of the set of quantum logic blocks based on the error rate information. The cost function includes a first component associated with the runtime of the set of quantum logic blocks; and a second component associated with the error rate of the set of quantum logic blocks, and the hyperparameter specifies a weighting of the second component relative to the first component. The method includes evaluating the cost function for respective sets of quantum logic blocks based on the error rate information and availability information in the hardware resource metadata associated with the respective sets of quantum logic blocks.

Implementations of the first example may include one or more of the following features. The quantum logic circuit is configured to be applied to a plurality of qubits. Each of the plurality of execution tasks includes a quantum logic block which includes a respective subset of the quantum logic operations. Each quantum logic block is configured to be applied to a subset of the plurality of qubits. Generating the plurality of execution tasks includes performing a wire cutting process. Each execution task specifies: one or more initial states determined by the wire cutting process; and one or more measurements determined by the wire cutting process.

Implementations of the first example may include one or more of the following features. The method includes receiving a stopping criterion for the requested execution of the computer program, and determining a number of iterations for each of the plurality of execution tasks based on the stopping criterion. the stopping criterion includes an error bound for the output of the computer program.

Implementations of the first example may include one or more of the following features. The availability information in the hardware resource metadata indicates a number of qubits available on the respective processing nodes. The plurality of execution tasks are configured to be applied to the number of qubits available on the respective processing nodes. The method includes generating an execution schedule for the plurality of execution tasks. The plurality of execution tasks are dispatched to the plurality of processing nodes according to the execution schedule. The number of execution tasks exceeds the number of processing nodes, and multiple of the execution tasks are dispatched to at least a subset of the plurality of processing nodes. The execution schedule includes logical synchronization points. The method includes iteratively receiving the output data from the at least a subset of the plurality of processing nodes; and combining subsets of the output data at the logical synchronization points according to the execution schedule.

Implementations of the first example may include one or more of the following features. The method includes generating a first execution schedule for the plurality of execution tasks; in response to failure of a first processing node of the processing nodes, identifying a logical synchronization point in the first execution schedule; truncating the first execution schedule by removing execution tasks associated with the first processing node after the logical synchronization point in the first execution schedule; and augmenting a second execution schedule with the truncated first execution schedule at the logical synchronization point. The second execution schedule includes an execution task for execution by a second processing node.

Implementations of the first example may include one or more of the following features. The computing system includes classical computing resources and quantum computing resources. The plurality of processing nodes include at least a subset of the quantum computing resources and at least a subset of the classical computing resources. The processing nodes include a first processing node and a second processing node. The first processing node includes a quantum processing unit that uses qubit devices to process a first subset of the plurality of execution tasks. The second processing node includes a virtual quantum machine that includes a classical processor to process a second subset of the plurality of execution tasks. Receiving output data includes receiving data buffers from the plurality of processing nodes. Each data buffer includes measured bitstring values, Pauli measurement outcomes, and runtime metadata.

In a second example, a computing system includes quantum computing resources and one or more classical computing resources communicably coupled to the quantum computing resources, the one or more quantum computing resources configured to perform one or more operations of the first example.

In a third example, a method of operating a computing system including quantum computing resources includes obtaining a quantum logic circuit including quantum logic operations; obtaining quantum hardware resource metadata indicating properties of processing nodes capable of executing respective portions of the quantum logic circuit, the processing nodes including at least a subset of the quantum computing resources in the computing system, the quantum hardware resource metadata including error rate information and availability information for the respective processing nodes; determining an execution program for a decomposition of the quantum logic circuit based on the quantum hardware resource metadata; causing execution tasks of the execution program to execute on the processing nodes consistent with the execution program; and determining an output of the quantum logic circuit, the output being based on intermediate outputs generated by the execution tasks being executed on the processing nodes.

Implementations of the third example may include one or more of the following features. The method includes obtaining hyperparameters associated with the quantum logic circuit, the hyperparameters comprising a cost function hyperparameter; and determining the decomposition of the quantum logic circuit using the cost function hyperparameter in a cost function. The method includes determining a runtime of a set of quantum logic blocks based on the availability information; and determining an error rate of the set of quantum logic blocks based on the error rate information. The cost function includes a first component associated with the runtime of the set of quantum logic blocks; and a second component associated with the error rate of the set of quantum logic blocks, and the cost function hyperparameter specifies a weighting of the second component relative to the first component. The method includes evaluating the cost function for respective sets of quantum logic blocks based on the error rate information and availability information in the hardware resource metadata associated with the respective sets of quantum logic blocks.

Implementations of the third example may include one or more of the following features. The hyperparameters include a stopping criterion, and the method includes determining a number of iterations for each of the plurality of execution tasks based on the stopping criterion. The availability information in the quantum hardware resource metadata includes a number of qubits available on the respective processing nodes, and the execution tasks are configured to be applied to the number of qubits available on the respective processing nodes. The execution program includes logical synchronization points, and the method includes iteratively receiving the intermediate outputs from the processing nodes; and combining subsets of the intermediate outputs at the logical synchronization points according to the execution program. Determining the execution program includes performing a wire cutting process. Each execution task specifies: one or more initial states determined by the wire cutting process; and one or more measurements determined by the wire cutting process.

Implementations of the third example may include one or more of the following features. The computing system includes classical computing resources and quantum computing resources, and the processing nodes include a first processing node and a second processing node. The first processing node includes qubit devices to process a first subset of the execution tasks. The second processing node includes a virtual quantum machine to process a second subset of the execution tasks. Causing execution tasks to execute on the processing nodes includes dispatching the execution tasks to respective processing nodes.

While this specification contains many details, these should not be understood as limitations on the scope of what may be claimed, but rather as descriptions of features specific to particular examples. Certain features that are described in this specification or shown in the drawings in the context of separate implementations can also be combined. Conversely, various features that are described or shown in the context of a single implementation can also be implemented in multiple implementations separately or in any suitable sub-combination.

Similarly, while operations are depicted in the drawings in a particular order, this should not be understood as requiring that such operations be performed in the particular order shown or in sequential order, or that all illustrated operations be performed, to achieve desirable results. In certain circumstances, multitasking and parallel processing may be advantageous. Moreover, the separation of various system components in the implementations described above should not be understood as requiring such separation in all implementations, and it should be understood that the described program components and systems can generally be integrated together in a single product or packaged into multiple products.

A number of embodiments have been described. Nevertheless, it will be understood that various modifications can be made. Accordingly, other embodiments are within the scope of the following claims.

What is claimed is:

1. A method of operating a computing system comprising quantum computing resources, the method comprising:
obtaining a computer program, the computer program comprising a quantum logic circuit comprising quantum logic operations;
obtaining hardware resource metadata specifying properties of a plurality of processing nodes in the computing system, the plurality of processing nodes comprising at least a subset of the quantum computing resources, the hardware resource metadata comprising error rate information and availability information for the respective processing nodes;
generating a plurality of execution tasks configured to execute the quantum logic circuit on the plurality of processing nodes, wherein each of the plurality of execution tasks comprises a respective subset of the quantum logic operations, and the plurality of execution tasks are generated based on the hardware resource metadata;
dispatching the plurality of execution tasks to the plurality of processing nodes;
receiving output data generated by the plurality of processing nodes executing the plurality of execution tasks; and
producing an output of the computer program based on the output data.

2. The method of claim 1, wherein the quantum logic circuit is configured to be applied to a plurality of qubits, each of the plurality of execution tasks comprises a quantum logic block comprising a respective subset of the quantum logic operations, and each quantum logic block is configured to be applied to a subset of the plurality of qubits.

3. The method of claim 2, comprising
obtaining a hyperparameter associated with a requested execution of the computer program; and
generating the plurality of execution tasks based on the hyperparameter and the hardware resource metadata.

4. The method of claim 3, wherein generating the plurality of execution tasks comprises determining the quantum logic blocks based on the hyperparameter in a cost function.

5. The method of claim 4, comprising:
determining a runtime of a set of quantum logic blocks based on the availability information; and
determining an error rate of the set of quantum logic blocks based on the error rate information,
wherein the cost function comprises:
a first component associated with the runtime of the set of quantum logic blocks; and
a second component associated with the error rate of the set of quantum logic blocks, and the hyperparameter specifies a weighting of the second component relative to the first component.

6. The method of claim 4, wherein comprising:
evaluating the cost function for respective sets of quantum logic blocks based on the error rate information and availability information in the hardware resource metadata.

7. The method of claim 2, wherein generating the plurality of execution tasks comprises performing a wire cutting process, and each execution task specifies:
one or more initial states determined by the wire cutting process; and
one or more measurements determined by the wire cutting process.

8. The method of claim 1, comprising receiving a stopping criterion for a requested execution of the computer program, and determining a number of iterations for each of the plurality of execution tasks based on the stopping criterion.

9. The method of claim 8, wherein the stopping criterion comprises an error bound for the output of the computer program.

10. The method of claim 1, wherein the availability information in the hardware resource metadata indicates a number of qubits available on the respective processing nodes, and the plurality of execution tasks are configured to be applied to the number of qubits available on the respective processing nodes.

11. The method of claim 1, further comprising generating an execution schedule for the plurality of execution tasks, wherein the plurality of execution tasks are dispatched to the plurality of processing nodes according to the execution schedule.

12. The method of claim 11, wherein the number of execution tasks exceeds the number of processing nodes, and multiple of the execution tasks are dispatched to at least a subset of the plurality of processing nodes.

13. The method of claim 11, wherein the execution schedule comprises logical synchronization points, and the method comprises:
iteratively receiving the output data from the plurality of processing nodes; and
combining subsets of the output data at the logical synchronization points according to the execution schedule.

14. The method of claim 1, comprising:
generating a first execution schedule for the plurality of execution tasks;
in response to failure of a first processing node of the processing nodes, identifying a logical synchronization point in the first execution schedule;
truncating the first execution schedule by removing execution tasks associated with the first processing node after the logical synchronization point in the first execution schedule; and
augmenting a second execution schedule with the truncated first execution schedule at the logical synchronization point, the second execution schedule comprising an execution task for execution by a second processing node.

15. The method of claim 1, wherein the computing system comprises classical computing resources and quantum computing resources, and the plurality of processing nodes comprise at least a subset of the quantum computing resources and at least a subset of the classical computing resources.

16. The method of claim 15, wherein the processing nodes comprise:
a first processing node comprising a quantum processing unit that uses qubit devices to process a first subset of the plurality of execution tasks; and
a second processing node comprising a virtual quantum machine that comprises a classical processor to process a second subset of the plurality of execution tasks.

17. The method of claim 1, wherein receiving output data comprises receiving data buffers from the plurality of processing nodes, wherein each data buffer comprises measured bitstring values, Pauli measurement outcomes, and runtime metadata.

18. A computing system comprising:
quantum computing resources; and
one or more classical computing resources communicably coupled to the quantum computing resources, the one or more classical computing resources configured to:
obtain a computer program, the computer program comprising a quantum logic circuit comprising quantum logic operations;
obtain hardware resource metadata specifying properties of a plurality of processing nodes in the computing system, the plurality of processing nodes comprising at least a subset of the quantum computing resources, the hardware resource metadata comprising error rate information and availability information for the respective processing nodes;
generate a plurality of execution tasks configured to execute the quantum logic circuit on the plurality of processing nodes, wherein each of the plurality of execution tasks comprises a respective subset of the quantum logic operations, and the plurality of execution tasks are generated based on the hardware resource metadata;
dispatch the plurality of execution tasks to the plurality of processing nodes;
receive output data generated by the plurality of processing nodes executing the plurality of execution tasks; and
produce an output of the computer program based on the output data.

19. The computing system of claim 18, wherein the quantum logic circuit is configured to be applied to a plurality of qubits, each of the plurality of execution tasks comprises a quantum logic block comprising a respective subset of the quantum logic operations, and each quantum logic block is configured to be applied to a subset of the plurality of qubits.

20. The computing system of claim 19, wherein the one or more classical computing resources are configured to:
obtain a hyperparameter associated with a requested execution of the computer program; and
generate the plurality of execution tasks based on the hyperparameter.

21. The computing system of claim 20, wherein generating the plurality of execution tasks comprises determining the quantum logic blocks based on the hyperparameter in a cost function.

22. The computing system of claim 21, wherein the one or more classical computing resources are configured to:
determine a runtime of a set of quantum logic blocks based on the availability information; and
determine an error rate of the set of quantum logic blocks based on the error rate information, and
wherein the cost function comprises:
a first component associated with the runtime of the set of quantum logic blocks; and
a second component associated with the error rate of the set of quantum logic blocks, and the hyperparameter specifies a weighting of the second component relative to the first component.

23. The computing system of claim 21, wherein the one or more classical computing resources are configured to:
evaluate the cost function for respective sets of quantum logic blocks based on the error rate information and availability information in the hardware resource metadata.

24. The computing system of claim 19, wherein generating the plurality of execution tasks comprises performing a wire cutting process, and each execution task specifies:
one or more initial states determined by the wire cutting process; and
one or more measurements determined by the wire cutting process.

25. The computing system of claim 18, wherein the one or more classical computing resources are configured to:
receive a stopping criterion for a requested execution of the computer program, and
determine a number of iterations for each of the plurality of execution tasks based on the stopping criterion.

26. The computing system of claim 25, wherein the stopping criterion comprises an error bound for the output of the computer program.

27. The computing system of claim 18, wherein the availability information in the hardware resource metadata indicates a number of qubits available on the respective processing nodes, and the plurality of execution tasks are configured to be applied to the number of qubits available on the respective processing nodes.

28. The computing system of claim 18, wherein the one or more classical computing resources are configured to:
generate an execution schedule for the plurality of execution tasks, wherein the plurality of execution tasks are dispatched to the plurality of processing nodes according to the execution schedule.

29. The computing system of claim 28, wherein the number of execution tasks exceeds the number of processing nodes, and multiple of the execution tasks are dispatched to at least a subset of the plurality of processing nodes.

30. The computing system of claim 28, wherein the execution schedule comprises logical synchronization points, and the one or more classical computing resources are configured to:
iteratively receive the output data from the plurality of processing nodes; and
combine subsets of the output data at the logical synchronization points according to the execution schedule.

31. The computing system of claim 18, wherein the one or more classical computing resources are configured to:
generate a first execution schedule for the plurality of execution tasks;
in response to failure of a first processing node of the plurality of processing nodes, identify a logical synchronization point in the first execution schedule;
truncate the first execution schedule by removing execution tasks associated with the first processing node after the logical synchronization point in the first execution schedule; and
augment a second execution schedule with the truncated first execution schedule at the logical synchronization point, the second execution schedule comprising an execution task for execution by a second processing node.

32. The computing system of claim 18, further comprising additional classical computing resources, wherein the plurality of processing nodes comprise at least a subset of the quantum computing resources and at least a subset of the additional classical computing resources.

33. The computing system of claim 32, wherein the plurality of processing nodes comprise:
a first processing node comprising a quantum processing unit that uses qubit devices to process a first subset of the plurality of execution tasks; and
a second processing node comprising a virtual quantum machine that comprises a classical processor to process a second subset of the plurality of execution tasks.

34. The computing system of claim 18, wherein receiving output data comprises receiving data buffers from the plurality of processing nodes, wherein each data buffer comprises measured bitstring values, Pauli measurement outcomes, and runtime metadata.

35. A method of operating a computing system comprising quantum computing resources, the method comprising:
obtaining a quantum logic circuit comprising quantum logic operations;
obtaining quantum hardware resource metadata indicating properties of processing nodes capable of executing respective portions of the quantum logic circuit, the processing nodes comprising at least a subset of the quantum computing resources in the computing system, the quantum hardware resource metadata comprising error rate information and availability information for the respective processing nodes;
determining an execution program for a decomposition of the quantum logic circuit based on the quantum hardware resource metadata;
causing execution tasks of the execution program to execute on the processing nodes consistent with the execution program; and
determining an output of the quantum logic circuit, the output being based on intermediate outputs generated by the execution tasks being executed on the processing nodes.

36. The method of claim 35, comprising:
obtaining hyperparameters associated with the quantum logic circuit, the hyperparameters comprising a cost function hyperparameter; and
determining the decomposition of the quantum logic circuit using the cost function hyperparameter in a cost function.

37. The method of claim 36, comprising:
determining a runtime of a set of quantum logic blocks based on the availability information; and
determining an error rate of the set of quantum logic blocks based on the error rate information,
wherein the cost function comprises:
a first component associated with the runtime of the set of quantum logic blocks; and
a second component associated with the error rate of the set of quantum logic blocks, and the cost function hyperparameter specifies a weighting of the second component relative to the first component.

38. The method of claim 36, comprising:
evaluating the cost function for respective sets of quantum logic blocks based on the error rate information and availability information in the hardware resource metadata associated with the respective sets of quantum logic blocks.

39. The method of claim 35, wherein the hyperparameters comprise a stopping criterion, and the method comprises:
determining a number of iterations for each of the plurality of execution tasks based on the stopping criterion.

40. The method of claim 35, wherein the availability information in the quantum hardware resource metadata comprises a number of qubits available on the respective processing nodes, and the execution tasks are configured to be applied to the number of qubits available on the respective processing nodes.

41. The method of claim 35, wherein the execution program comprises logical synchronization points, and the method comprises:
iteratively receiving the intermediate outputs from the processing nodes; and
combining subsets of the intermediate outputs at the logical synchronization points according to the execution program.

42. The method of claim 35, wherein determining the execution program comprises performing a wire cutting process, and each execution task specifies:
one or more initial states determined by the wire cutting process; and
one or more measurements determined by the wire cutting process.

43. The method of claim 35, wherein the computing system comprises classical computing resources and quantum computing resources, and the processing nodes comprise:
a first processing node comprising qubit devices to process a first subset of the execution tasks; and
a second processing node comprising a virtual quantum machine to process a second subset of the execution tasks.

44. The method of claim 35, wherein causing the execution tasks to execute on the processing nodes comprises dispatching the execution tasks to the respective processing nodes.
